(19) United States
(12) Patent Application Publication
(10) Pub. No.: US 2026/0330746 A1
(43) Pub. Date: Oct. 22, 2026

(54) METHODS AND SYSTEMS FOR SIGNALING OBSERVER POSITION INFORMATION FOR THREE-DIMENSIONAL GAUSSIAN SPLAT SCENE REPRESENTATIONS

(71) Applicant: Tencent America LLC, Palo Alto, CA (US)

(72) Inventor: Stephan WENGER, Palo Alto, CA (US)

(21) Appl. No.: 19/643,404

(22) Filed: Apr. 9, 2026

Related U.S. Application Data
(60) Provisional application No. 63/789,895, filed on Apr. 16, 2025.

(51) Int. Cl. G06T 15/08; G06V 10/25; H04N 19/597; H04N 19/70

(52) U.S. Cl. CPC G06T 15/08; G06V 10/25; H04N 19/597; H04N 19/70

(57) ABSTRACT

An example decoding method includes obtaining a bitstream comprising a 3D Gaussian splat scene representation, and parsing, from the bitstream, at least one syntax element indicating observer position information. The observer position information includes at least one of: at least one source camera position associated with the 3D Gaussian splat scene representation, or a volume of space indicating allowed observer positions for rendering the 3D Gaussian splat scene representation. The example method also includes rendering the 3D Gaussian splat scene representation based on the observer position information.

### RELATED APPLICATIONS

This application claims priority to U.S. Provisional Patent Application No. 63/789,895 entitled “SEI Message for Camera Position or Allowed View Space,” filed Apr. 16, 2025, which is hereby incorporated by reference in its entirety.

### TECHNICAL FIELD

The present disclosure relates to signaling three-dimensional scene representation, including but not limited to, methods and systems for signaling Gaussian splat information.

### BACKGROUND

Three-dimensional Gaussian splatting (3DGS) can be used to represent and render three-dimensional scenes. Gaussian splats refer to volume rendering techniques that represent scenes with 3D Gaussians that retain properties of continuous volumetric radiance fields, integrating sparse points produced during camera calibration. Various standards bodies have undertaken efforts to develop standards related to Gaussian splat compression, storage, and transmission. In 3DGS workflows, a scene is captured using one or more cameras, and the resulting images are processed to generate Gaussian splat representations. When the Gaussian splat data is subsequently rendered, visual artifacts may occur. These artifacts can manifest as splats appearing larger or smaller than expected, improper overlap between splats, and unpredictable variations in rendered image density. In animated scenes, such discrepancies may result in flickering over uniform areas.

### SUMMARY

The present disclosure provides techniques for signaling observer position information in bitstreams carrying three-dimensional (3D) Gaussian splat scene representations. The observer position information may include at least one source camera position associated with the 3D Gaussian splat scene representation, a volume of space indicating allowed observer positions for rendering the 3D Gaussian splat scene representation, or both. In some embodiments, the observer position information is conveyed using Supplemental Enhancement Information (SEI) messages, which may be included in coded video bitstreams or point cloud coding bitstreams. The volume of space indicating allowed observer positions may be represented using various formats, including a 3D bounding box defined by a position and size, an intersection between a sphere and a pyramid defined by spherical coordinates, a quaternion-based rectangular region on a sphere, or a convex hull intersection on a sphere defined by a plurality of points. The signaling of observer position information may provide the decoder and renderer with an indication as to the accuracy of rendering splats based on the relationship between the view camera position and the source camera positions. The rendering quality may be highest when the virtual camera position corresponds to one of the source camera positions, and the quality may degrade as the virtual camera position moves further from the source camera positions. The observer position information may be signaled as source camera positions, which is simple to encode but requires the renderer to perform calculations to determine suitable viewing positions, or as pre-computed viewing positions, which saves computational cycles at the renderer but may be less flexible for scenarios where multiple Gaussian splat files are combined. In some embodiments, both source camera positions and pre-calculated suitable viewing positions are signaled, providing a tradeoff between encoder and decoder complexity. Additional camera parameters such as focal length, lens characteristics, exposure settings, and image settings may also be signaled to further improve rendering accuracy.

In accordance with some embodiments, a method of processing a three-dimensional (3D) scene representation includes: (i) obtaining a bitstream comprising a 3D Gaussian splat scene representation; (ii) parsing, from the bitstream, at least one syntax element indicating observer position information, where the observer position information comprises at least one of: (a) at least one source camera position associated with the 3D Gaussian splat scene representation, or (b) a volume of space indicating allowed observer positions for rendering the 3D Gaussian splat scene representation; and (iii) rendering the 3D Gaussian splat scene representation based on the observer position information.

In accordance with some embodiments, a method of generating a bitstream comprising a three-dimensional (3D) Gaussian splat scene representation includes: (i) acquiring a plurality of images of a scene using one or more cameras; (ii) determining, for each of the one or more cameras, a camera position and a camera orientation; (iii) generating the 3D Gaussian splat scene representation based on the plurality of images and the camera positions and camera orientations; (iv) generating at least one syntax element indicating observer position information, where the observer position information comprises at least one of: (a) at least one source camera position associated with the 3D Gaussian splat scene representation, or (b) a volume of space indicating allowed observer positions for rendering the 3D Gaussian splat scene representation; and (v) encoding the 3D Gaussian splat scene representation and the at least one syntax element into the bitstream.

In accordance with some embodiments, a computing system includes one or more processors and one or more non-transitory computer-readable media storing instructions that, when executed by the one or more processors, cause the computing system to perform any of the methods and techniques described herein. In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding, signaling, and decoding Gaussian splat data. Such methods, devices, and systems may complement or replace conventional methods, devices, and systems for encoding, signaling, and/or decoding Gaussian splat data.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2 is a block diagram illustrating an example computing system in accordance with some embodiments.

FIG. 3 is a flowchart illustrating an example method for generating Gaussian splats in accordance with some embodiments.

FIG. 4 is a flowchart illustrating an example method for rendering Gaussian splats in accordance with some embodiments.

FIG. 5 is a flowchart illustrating an example method for analyzing viewpoints in accordance with some embodiments.

FIG. 6 is a flowchart illustrating an example method for compressing and decompressing Gaussian splats in accordance with some embodiments.

FIG. 7 is a flowchart illustrating an example method for analyzing compression outputs in accordance with some embodiments.

FIGS. 8A-8F illustrate example scenes in accordance with some embodiments.

FIGS. 9A-9B are flowcharts illustrating example methods of encoding and decoding Gaussian splat information in accordance with some embodiments.

In accordance with common practice, the various features illustrated in the drawings are not necessarily drawn to scale, and like reference numerals can be used to denote like features throughout the specification and figures.

### DETAILED DESCRIPTION

Three-dimensional (3D) rendering involves generating two-dimensional images from three-dimensional scene representations. Various techniques exist for representing 3D scenes, including meshes, point clouds, and volumetric representations. 3D Gaussian splatting (3DGS), also referred to as Gaussian splatting Radiance Field, is an explicit radiance field-based 3D representation that represents 3D scenes and/or objects using many discrete 3D splats. Each Gaussian splat may be defined by its spatial mean and covariance matrix, which together define the position, size, and orientation of the splat in 3D space. Gaussian splats may also include parameters for opacity, color, and/or view-dependent appearance characteristics encoded through spherical harmonics. A 3D Gaussian splat representation of a scene may be in the form of a sparse point cloud, where each point has attributes that in combination define the 3D Gaussian. In 3DGS workflows, a scene is captured using one or more cameras, and the resulting images are processed to generate Gaussian splat representations. The Gaussian splat parameters may be adjusted in an iterative training process to minimize a loss function between the input images and rendered images. The trained Gaussian splat representation may then be compressed for storage and/or transmission, and subsequently decompressed and rendered for viewing.

The present disclosure provides techniques for signaling observer position information in bitstreams carrying 3D Gaussian splat scene representations. The observer position information may include at least one source camera position associated with the 3D Gaussian splat scene representation, a volume of space indicating allowed observer positions for rendering the 3D Gaussian splat scene representation, or both. As a real-world example, consider a soccer ball that is photographed from all angles on the outside using multiple cameras. From these images, a 3D Gaussian splat representation of the soccer ball can be generated that accurately captures every detail of the exterior surface. However, if a virtual camera were placed inside the soccer ball during rendering, the resulting image would contain artifacts with no relationship to reality, because no source cameras captured the interior of the soccer ball. By signaling the source camera positions (or the allowed viewspace derived therefrom) to the decoder and renderer, the renderer can assess the accuracy of rendering based on the relationship between the virtual camera position and the source camera positions. The renderer may use this information to determine whether a requested viewing position is suitable, to provide feedback to the user regarding rendering quality, and/or to restrict navigation to positions where acceptable rendering quality can be achieved.

### Example Systems and Devices

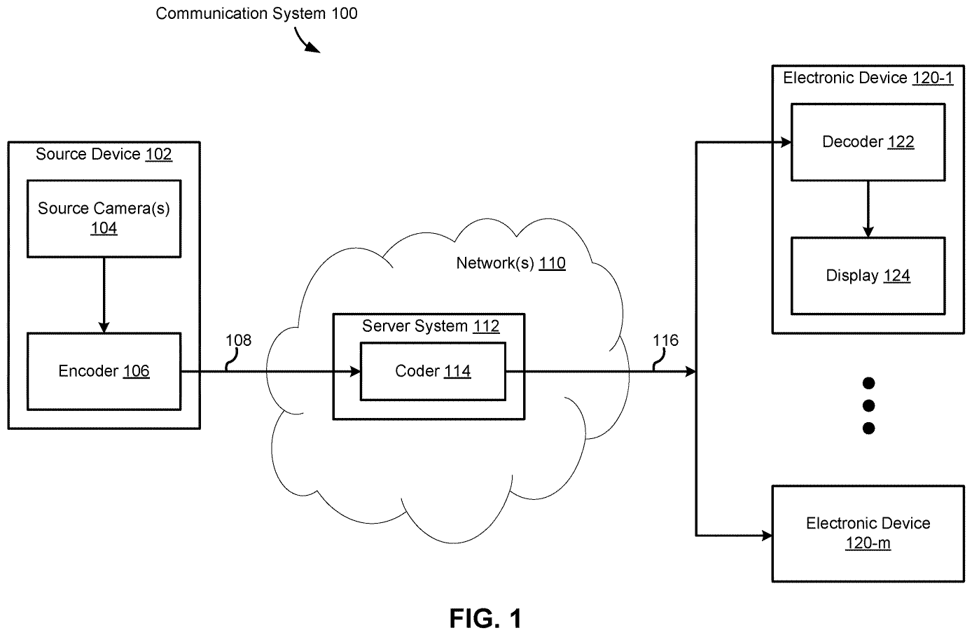

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with volumetric media applications such as three-dimensional Gaussian splat streaming applications, immersive video conferencing applications, and/or volumetric media storage and/or distribution applications.

The source device 102 includes source camera(s) 104 (e.g., a camera rig, depth camera array, RGB-D camera system, and/or media storage) and an encoder component 106. In some embodiments, the source camera(s) 104 are a set of calibrated cameras configured to capture images representing objects or scenes. The camera positions and orientations relative to the captured scene may be known, fixed in relation to each other, or may overlap so that their relative positions and orientations can be inferred from the captured content. For example, the source camera(s) 104 may consist of numerous hand-held cell phone cameras that take overlapping pictures and/or videos of the same scene. Certain techniques such as, for example, structure from motion techniques may be used to determine camera positions. Source camera parameters may be extracted from the camera images when available. For example, many still image and some motion cameras may include EXIF data associated with images/videos. If no such information is available, the structure from motion mechanism may be able to construct a limited set of those parameters, including focal length. Source camera parameters may also be hand-configured and made available to the scene acquisition unit for inclusion in the Gaussian splat file. The cameras may output any suitable still and/or motion format, including compressed formats. The encoder component 106 generates one or more encoded bitstreams from the captured image data. The Gaussian splat data generated from the source camera(s) 104 may be high data volume as compared to the encoded bitstream 108 generated by the encoder component 106. Because the encoded bitstream 108 is lower data volume (less data) as compared to the uncompressed Gaussian splat data, the encoded bitstream 108 requires less bandwidth to transmit and less storage space to store. In some embodiments, the source device 102 does not include the encoder component 106 (e.g., is configured to transmit uncompressed Gaussian splat data to the network(s) 110).

In some embodiments, the source device 102 includes a scene acquisition unit configured to receive the images and/or videos from the source camera(s) 104, as well as pre-established or created information pertaining to the cameras' orientation and position. The scene acquisition unit may be configured to put the received images and/or videos into relation to each other and calculate a three-dimensional scene representation of the scene using Gaussian splats. The encoder component 106 may employ lossless and/or lossy compression techniques. Source camera parameters may advantageously be included in the trained Gaussian splat files (e.g., PLY files), the compressed representation of those files, the real-time transmission chain (if used) between encoder and decoder, and/or the decompressed Gaussian splat scene. The resulting compressed bitstream may be stored in a file and/or transmitted directly to a receiver. The file may be in a format that enables, for example, demand-based streaming. The file, or parts thereof, may be conveyed to a decoder, for example using network transmission and real-time protocols such as RTP, streaming technologies such as DASH, file transfer, physical transfer using portable memory such as a USB stick, and/or any other suitable technique.

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks, and/or the Internet.

The one or more networks 110 include a server system 112 (e.g., a distributed/cloud computing system). In some embodiments, the server system 112 is, and/or includes, a streaming server (e.g., configured to store and/or distribute volumetric content such as the encoded Gaussian splat data from the source device 102). The server system 112 includes a coder component 114 (e.g., configured to encode and/or decode Gaussian splat data). In some embodiments, the coder component 114 includes an encoder component and/or a decoder component. In various embodiments, the coder component 114 is instantiated as hardware, software, and/or a combination thereof. In some embodiments, the coder component 114 is configured to decode the encoded bitstream 108 and re-encode the Gaussian splat data using a different encoding standard and/or methodology to generate encoded data 116. In some embodiments, the server system 112 is configured to generate multiple formats and/or encodings from the encoded bitstream 108, such as different quality levels. In some embodiments, the server system 112 functions as a Media-Aware Network Element (MANE). For example, the server system 112 may be configured to process the encoded bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded data 116 to generate reconstructed Gaussian splat data that can be rendered on a display and/or other type of rendering device. Depending on the compression/decompression mechanism, the reconstructed Gaussian splat representation may be a bit-exact copy of the original scene description, or a suitable approximation thereof. The reconstructed representation may be made available to a renderer which may convert the Gaussian splats into a format suitable for viewing, possibly taking viewer input such as viewer position into account. In some embodiments, the decoder component 122 parses source camera parameters from the encoded data 116 and interprets Gaussian splat parameters based on the source camera parameters during rendering. The renderer is aware of the view camera's parameters (e.g., focal length) as the view camera is part of the renderer. In some embodiments, the display 124 is any suitable display, ranging from 2D screens on cell phones, tablets, PCs, TVs, over immersive display devices such as AR/VR goggles, to holographic display units. In some embodiments, one or more of the electronic devices 120 does not include a display component (e.g., is communicatively coupled to an external display device such as a head-mounted display and/or includes a media storage). In some embodiments, the electronic devices 120 are streaming clients. In some embodiments, the electronic devices 120 are configured to access the server system 112 to obtain the encoded data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, and/or laptop), a wearable device, a volumetric video conferencing device, a head-mounted display, and/or other type of electronic device.

In example operation of the communication system 100, the source device 102 transmits the encoded bitstream 108 to the server system 112. For example, the source device 102 may encode Gaussian splat data representing three-dimensional objects and/or scenes that are captured by the source camera(s) 104. Source camera parameters associated with the source camera(s) 104 may be included in the encoded bitstream 108. The server system 112 receives the encoded bitstream 108 and may decode and/or encode the encoded bitstream 108 using the coder component 114. For example, the server system 112 may apply an encoding to the Gaussian splat data that is more optimal for network transmission and/or storage. The server system 112 may transmit the encoded data 116 (e.g., one or more coded bitstreams) to one or more of the electronic devices 120. Each electronic device 120 may decode the encoded data 116 and render the decoded Gaussian splat data, optionally interpreting Gaussian splat parameters based on source camera parameters parsed from the decoded data.

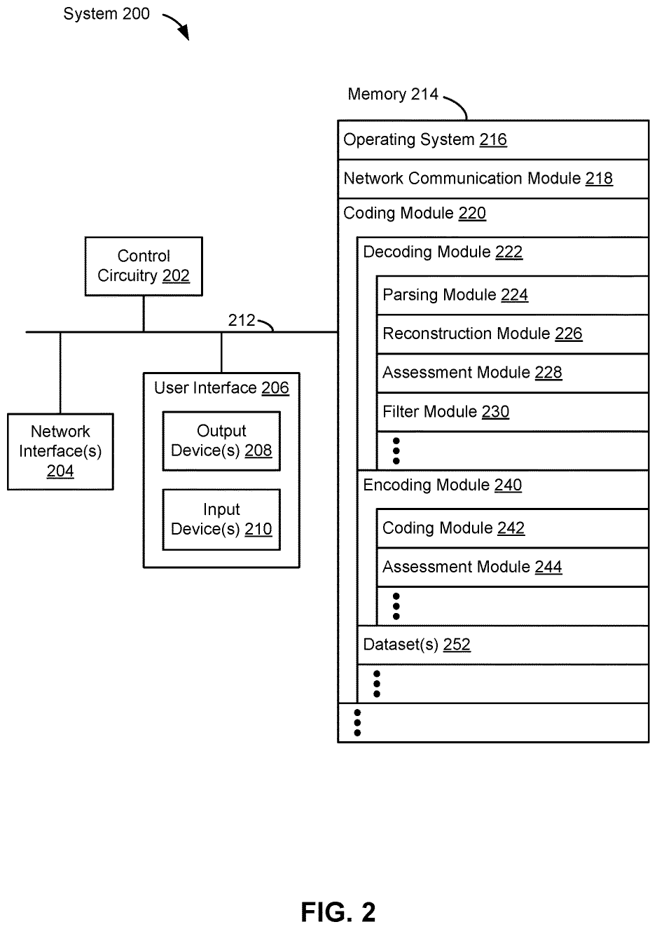

FIG. 2 is a block diagram illustrating a computing system 200 in accordance with some embodiments. The computing system 200 may be an instance of the server system 112, the source device 102, and/or one of the electronic devices 120. In some embodiments, the computing system 200 is configured to perform Gaussian splat coding operations, including encoding and/or decoding Gaussian splat data. The computing system 200 includes control circuitry 202, one or more network interfaces 204, a memory 214, a user interface 206, and one or more communication buses 212 for interconnecting these components. In some embodiments, the control circuitry 202 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 204 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Some networks require external network interface adapters that attach to certain general purpose data ports or peripheral buses (such as USB ports of the computing system 200); others are integrated into the core of the computing system 200 by attachment to a system bus (for example Ethernet interface into a PC computer system or cellular network interface into a smartphone computer system). Certain protocols and protocol stacks can be used on each of those networks and network interfaces. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 206 includes one or more output devices 208 and/or one or more input devices 210. The input device(s) 210 may be responsive to input by one or more human users through, for example, tactile input (such as keystrokes, swipes, and/or data glove movements), audio input (such as voice and/or clapping), and/or visual input (such as gestures). The input device(s) 210 can also be used to capture certain media not necessarily directly related to conscious input by a human, such as audio (such as speech, music, and/or ambient sound), images (such as scanned images and/or photographic images obtained from a still image camera), and/or video (such as two-dimensional video and/or three-dimensional video including stereoscopic video). The input device(s) 210 may include one or more of: a keyboard, a mouse, a trackpad, a touch screen, a data-glove, a joystick, a microphone, a scanner, a camera, and/or the like. The output device(s) 208 may include one or more of: tactile output devices (for example tactile feedback by a touch-screen, data-glove, and/or joystick), audio output devices (such as speakers and/or headphones), and/or visual output devices (such as screens including CRT screens, LCD screens, plasma screens, and/or OLED screens, each with or without touch-screen input capability, each with or without tactile feedback capability, some of which may be capable of outputting two-dimensional visual output and/or more than three-dimensional output through means such as stereographic output, virtual-reality glasses, and/or holographic displays).

The computing system 200 can also include human accessible storage devices and their associated media such as optical media including CD/DVD ROM/RW, thumb-drives, removable hard drives and/or solid state drives, legacy magnetic media such as tape and/or floppy disc, specialized ROM/ASIC/PLD based devices such as security dongles, and/or the like.

The memory 214 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 214 optionally includes one or more storage devices remotely located from the control circuitry 202. The memory 214, or, alternatively, the non-volatile solid-state memory device(s) within the memory 214, includes a non-transitory computer-readable storage medium. Those skilled in the art should understand that the term “computer readable media” as used in connection with the presently disclosed subject matter does not encompass transmission media, carrier waves, or other transitory signals. The control circuitry 202, memory 214, and other components may be connected through a system bus. In some embodiments, the system bus is accessible in the form of one or more physical plugs to enable extensions by additional CPUs, GPUs, and/or the like. Peripheral devices can be attached either directly to the system bus and/or through a peripheral bus. Architectures for a peripheral bus include PCI, USB, and/or the like. In some embodiments, the memory 214, or the non-transitory computer-readable storage medium of the memory 214, stores the following programs, modules, instructions, and data structures, or a subset or superset thereof:
an operating system 216 that includes procedures for handling various basic system services and for performing hardware-dependent tasks;
a network communication module 218 that is used for connecting the computing system 200 to other computing devices via the one or more network interfaces 204 (e.g., via wired and/or wireless connections);
a coding module 220 for performing various functions with respect to encoding and/or decoding data, such as three-dimensional Gaussian splat data. The coding module 220 including, but not limited to, one or more of:
   a decoding module 222 for performing various functions with respect to decoding encoded data, such as reconstructing Gaussian splat parameters; and
   an encoding module 240 for performing various functions with respect to encoding data, such as compressing Gaussian splat parameters; and
a dataset(s) 252 for storing Gaussian splat data, e.g., for use with the coding module 220. In some embodiments, the dataset(s) 252 includes one or more of: a reference data memory for storing source Gaussian splat data, a buffer memory for storing intermediate Gaussian splat data during processing, and a current data memory for storing reconstructed Gaussian splat data.

In some embodiments, the decoding module 222 includes a parsing module 224 for parsing encoded bitstreams (e.g., Gaussian splat bitstreams), a reconstruction module 226 (e.g., configured to perform the various functions to reconstruct compressed/streamed Gaussian splat data), an assessment module 228 (e.g., configured to perform the various functions to assess the quality of Gaussian splat reconstructions), and a filter module 230 (e.g., configured to perform the various functions related to filtering Gaussian splat data). In some embodiments, the assessment module 228 is configured to select viewpoints for evaluating reconstructed Gaussian splats, render the Gaussian splats from the selected viewpoints, and compute quality metrics based on the rendered views. The assessment module 228 may implement viewpoint selection techniques including random viewpoint selection, uniform angular spacing, exclusion ranges, multiple rotation axes, spherical coordinate systems, variable viewing distances, and Fibonacci sphere sampling.

In some embodiments, the encoding module 240 includes a coding module 242 (e.g., configured to perform the various functions to encode Gaussian splat data) and an assessment module 244 (e.g., configured to perform the various functions to assess the quality of potential Gaussian splat encodings and subsequent reconstructions using projection-based quality metrics). In some embodiments, the decoding module 222 and/or the encoding module 240 include a subset of the modules shown in FIG. 2. For example, a shared assessment module may be used by both the decoding module 222 and the encoding module 240 to evaluate Gaussian splat quality, e.g., using viewpoint-based rendering and two-dimensional image quality metrics.

Each of the above identified modules stored in the memory 214 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 220 optionally does not include separate decoding and encoding modules, but rather uses a same set of modules for performing both sets of functions. In some embodiments, the memory 214 stores a subset of the modules and data structures identified above. In some embodiments, the memory 214 stores additional modules and data structures not described above, such as rendering modules for generating two-dimensional projections of Gaussian splats from selected viewpoints, random number generators for viewpoint selection, and modules for computing two-dimensional image quality metrics. The control circuitry 202 can execute certain instructions that, in combination, make up computer code for performing the various functions described herein. The computer code can be stored in ROM and/or RAM. Transitional data can also be stored in RAM, whereas permanent data can be stored in internal mass storage. Fast storage and retrieval to any of the memory devices can be enabled through the use of cache memory, which can be closely associated with one or more processors, mass storage, ROM, RAM, and/or the like.

Although FIG. 2 illustrates the computing system 200 in accordance with some embodiments, FIG. 2 is intended more as a functional description of the various features that may be present in one or more computing systems configured for Gaussian splat coding and quality assessment rather than a structural schematic of the embodiments described herein. In practice, items shown separately could be combined and some items could be separated. For example, some items shown separately in FIG. 2 could be implemented on single servers and single items could be implemented by one or more servers. The actual number of servers used to implement the computing system 200, and how features are allocated among them, will vary from one implementation to another and, optionally, depends in part on the complexity of the Gaussian splat data being processed, the number of viewpoints used for quality assessment, and the computational requirements of the rendering and quality metric calculations.

### Example Coding Techniques

The coding processes and techniques described below may be performed at the devices and systems described above (e.g., the source device 102, the server system 112, and/or the electronic device 120). 3D Gaussian splatting (3DGS) is an explicit radiance field-based 3D representation that represents 3D scenes and/or objects using many discrete 3D splats, each defined by its spatial mean μ and covariance matrix Σ:

$$G ( p ) = exp ( - \frac{1}{2} {( p - μ )}^{T} {\sum }^{- 1} ( p - μ ) ) \qquad Equation 1$$

The covariance matrix Σ may be parameterized using a scaling matrix S and a rotation matrix R, such that Σ=RSS^{T}R^{T}. Each 3D Gaussian may be associated with a color c and an opacity α. During rendering, these Gaussians may be projected (rasterized) onto the image plane, forming 2D Gaussian splats G′(x). The 2D Gaussian splats may be sorted from front to back tile-wise, and a-blending may be performed for each pixel x to render its color as follows:

$$C ( x ) = {\sum }_{i ∈ N} {c}_{i} {σ}_{i} {\prod }_{j = 1}^{i - 1} ( 1 - {σ}_{j} ) , {σ}_{j} = {α}_{i} {G}_{i}^{′} ( x ) \qquad Equation 2$$

The color of each Gaussian, c, may be represented by Spherical Harmonics (SH) as kₗ^{m} Yₗ^{m} (ω_view) to provide view-dependent effects, where (l, m) is the degree and order of the SH basis Yₗ^{m}, kₗ^{m} is the corresponding SH coefficient, and ω_view specifies the viewing direction.

A 3D Gaussian splat representation of a scene may be in the form of a sparse point cloud. A point in such a point cloud may have implied position information, such as the point's position in space, represented for example by Cartesian and/or polar coordinates. Further, each point may have attributes. Some attributes are briefly introduced below. Position vector: (x, y, z) may represent the position of the point in the point cloud using a Cartesian coordinate system. Other coordinate systems, such as polar coordinates, may also be used. Rotation quaternion: (r₀, r₁, r₂, r₃) may be components of the matrix R.

Color vector: (r, g, b) may represent the color of the splat in RGB color space. Other color spaces may also be used and may result in the color vector including more or fewer than three component values. If a greyscale (instead of a color) 3D representation is desired, some information related to color may be omitted in the color vector. Scale vector: (s₀, s₁, s₂) may be components of the matrix S. Opacity value: (α) may be an indication of the opacity of the splat. Spherical harmonics values: In some embodiments, 45 spherical harmonics values (15 vectors) may be used.

The color may be obtained from:

$${C}_{i} = {\sum }_{i = 0}^{14} {c}_{i} \cdot {Y}_{i} ( v ) \qquad Equation 3$$

where v=(x, y, z) is the normalized viewing direction, cᵢ=(rᵢ, gᵢ, bᵢ) is the RGB spherical harmonic (SH) coefficient for basis i, with i∈[0,14] and Yᵢ(v) is the value of the real spherical harmonic basis function i in direction v. The rasterized colors may be obtained by blending the colors of the splats along a ray, where cᵢ is the color of each point and αᵢ is given by evaluating a 2D Gaussian with covariance Σ.

In some embodiments, an uncompressed version of the Gaussian splat representation is stored in the Polygon File Format (PLY). Other file formats that may represent one or more Gaussian splats are also known and/or may be devised by a person skilled in the art. Source camera position and direction (also known as orientation) may be stored using various formats. Several example formats are described below.

In some embodiments, the orientation is stored in the file, per camera, as a vector (dₓᵢ, d_{yi}, d_{zi}), and the position is stored as coordinates in a Cartesian and/or polar coordinate system.

Various representations may be used to store the input positions. In some embodiments, a list of positions is stored as:

P={(pₓᵢ,p_{yi},p_{zi}) with i in {1,2, . . . ,n}}

In some embodiments, a list of positions and directions is stored as:

P={(pₓᵢ,p_{yi},p_{zi},dₓᵢ,d_{yi},d_{zi}) with i in {1,2, . . . ,n}}

In some embodiments, a list of positions and directions is stored using quaternions. Using quaternions may have the advantage of storing not only the direction but also the rotation around the direction axis and may be easier to manipulate in 3D space:

P={(pₓᵢ,p_{yi},p_{zi},qₓᵢ,q_{yi},q_{zi},q_{wi}) with i in {1,2, . . . ,n}}

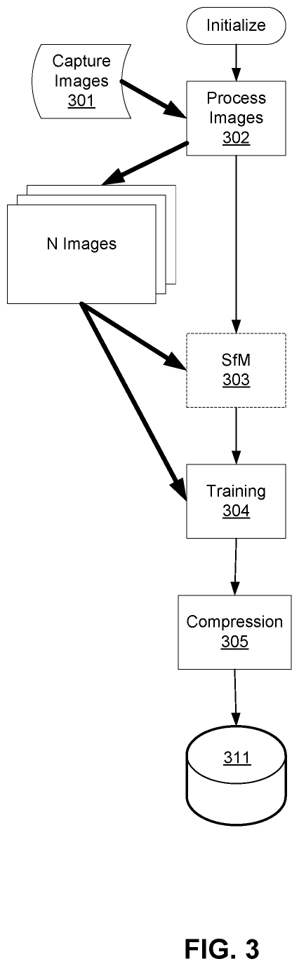

Referring to FIG. 3, a method for generating Gaussian splats is illustrated in accordance with some embodiments. The method begins with a step 301, where images are captured using one or more cameras. The captured images may be obtained from the source camera(s) 104 of the source device 102. The cameras may capture images at approximately the same time, and the images may be made available for subsequent processing. The step 301 may involve synchronizing the cameras, taking the closest-in-time picture received from each camera of a rig, and/or similar techniques. For a single scene acquisition, the step 301 may be performed once. For a scene video, the step 301 may be performed once for each captured scene.

Following the step 301, the method proceeds to a step 302, where the captured images are processed. The step 302 may involve one or more of: decoding of a compressed image format in case a compressed format was provided by a camera, color and/or brightness normalization, adjustment of the image based on optical and/or lens parameters, and/or color space conversion. The result of the step 302 may be N images that are made available for subsequent processing. The image processing operations performed in the step 302 may vary depending on the format and/or characteristics of the captured images. For example, if the source camera(s) 104 output compressed image formats, the step 302 may include decoding operations to obtain uncompressed image data. Color and/or brightness normalization may be performed to account for differences in exposure and/or white balance settings among the cameras. Color space conversion may be performed to convert images from one color space (e.g., RGB) to another color space (e.g., YCbCr) that may be more suitable for subsequent processing.

With continued reference to FIG. 3, the method proceeds to an optional step 303, which involves structure from motion (SfM) processing. The step 303 may be performed if the camera positions and/or lens characteristics are not a priori known and/or configured. In the step 303, for one or more of the images, the position and/or characteristics of the image's capturing camera may be determined. Such position information may be used later in constructing the three-dimensional scene information. The SfM processing may provide camera position and/or camera orientation information. Camera position may include the three-dimensional coordinates where each camera was placed during image capture. Camera orientation may describe the direction in which each camera is pointing, and the orientation may be provided as rotation matrices and/or quaternions.

The source camera parameter may be obtained from an SfM algorithm such as Colmap. Colmap computes the 3D coordinate position (pₓ, p_{y}, p_{z}) and direction (dₓ, d_{y}, d_{z}) of each input view. In Colmap, the orientation may be given by a 3×3 rotation matrix that transforms the camera's local coordinates into global coordinates, and/or a vector may be used to store, in a global coordinate system, the location of the camera. Other SfM algorithms may also be used, and the choice of SfM algorithm may depend on factors such as the number of input images, the complexity of the scene, and/or the desired accuracy of the camera position estimates.

Following the step 303, the method proceeds to a step 304 for training. In the step 304, the N images obtained in the step 302 along with the N camera positions obtained from the step 303 (and/or from a fixed configuration information of the rig) may be used to generate a set of Gaussian splats. The step 304 may involve the initial generation of K Gaussian splats, where K may be derived from the complexity of the scene as represented by the N images, as well as the desired rendering quality and/or constraints of maximum file size and/or transmission bandwidth. The parameters of the K Gaussian splats may be adjusted, e.g., in an iterative process, such that after a sufficient number of iterations the later rendering yields an acceptable quality representation of the Gaussian splats-represented three-dimensional scene after conversion into a rendering format.

The Gaussian splat training process may use gradient optimization, where the parameters of each Gaussian are iteratively refined to minimize a loss function between the input images and the rendered images. Differentiable rendering frameworks may allow backpropagation of this loss through the rendering pipeline, enabling efficient optimization by gradient descent and/or similar methods. In practice, the optimization process may be initialized with SfM outputs, such as camera parameters and/or point clouds, to provide a reasonable starting point. The optimization may then jointly refine appearance and/or geometry to improve image consistency.

To improve stability and/or convergence during optimization, several regularization terms may be incorporated. The Gaussian splat training process may incorporate scale regularization to prevent Gaussians from becoming excessively large by penalizing their spatial extent. The Gaussian splat training process may incorporate opacity regularization to discourage unnecessarily high alpha values, thus reducing visual clutter and/or improving sparsity. The Gaussian splat training process may incorporate spherical harmonics (SH) coefficient regularization to limit overfitting and/or artifacts by limiting the energy of view-dependent appearance terms. Additionally, a pruning strategy may be applied to remove Gaussians whose opacity and/or contribution to the rendered image is negligible, speeding up rendering and/or providing a more compact representation.

With continued reference to FIG. 3, following the step 304, the method proceeds to a step 305 for compression. For efficient storage and/or transmission, in some cases it may be desirable and/or necessary to compress the uncompressed Gaussian splat representation. Basic compression techniques may include lossless compression techniques such as zip. In more advanced scenarios, values in the Gaussian splat file may be processed through processes such as quantization and/or transformation to be representable in fewer bits, especially after entropy coding. Such steps may involve lossy compression, which may lead to a non-bit-exact reconstruction of the Gaussian splat parameters and, after rendering, in invisible and/or visible artifacts in the reconstructed and rendered scene.

The Gaussian splat compression process may include a pruning step that removes Gaussian splats based on a threshold. The pruning step may remove Gaussian splats that are hidden from observation from any allowed viewspace. The pruning step may remove Gaussian splats based on their size, distance from scene origin, and/or distance from the allowed viewspace. The pruning step may remove high-order spherical harmonics parameters from individual Gaussian splats rather than removing entire splats. By removing parameters that contribute minimally to the rendered output, the compression process may achieve reduced data volume without significantly degrading visual fidelity.

The compression process may include a sorting step using a neural network to arrange Gaussian splat parameters into planes suitable for image compression. The sorting step may rearrange Gaussian splat parameters to improve compression efficiency by grouping similar values together. Following sorting, quantization may convert floating point values to fixed-length formats suitable for image and/or video compression. The quantized data may proceed to a plane arrangement step, where the Gaussian splat parameters are organized into two-dimensional planes of samples. An encoding step may then compress the arranged planes using image and/or video compression mechanisms. A multiplexing step may combine the encoded data with metadata to produce a compressed output.

The compression techniques may involve employing known techniques to compress point clouds, such as those developed and standardized by MPEG, where the many parameters of Gaussian splats may form attributes beyond those of a traditional point cloud point. The output of the compression process may be stored in an output 311, which represents a file and/or bitstream that is in most cases smaller than an uncompressed PLY file, suitable for transmission and/or long-term storage. In some cases, the complete bitstream may be needed for meaningful decompression. In other cases, the bitstream may include codepoints that allow a storage/transmission chain and/or a renderer to reconstruct only parts of the bitstream, at reduced quality levels. Such techniques may be known as scalability. Scalable bitstreams may have advantages over non-scalable bitstreams in scenarios where transmitting the whole three-dimensional scene is not possible and/or uneconomical, as a viable representation comprising less than all layers may be available that is suitable for transmission.

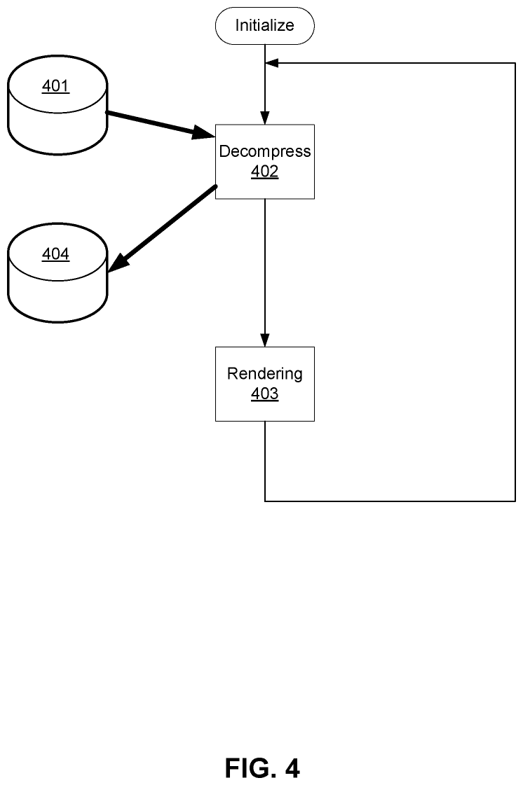

Referring to FIG. 4, a method for rendering Gaussian splats is illustrated in accordance with some embodiments. The method receives input from a compressed file (or bitstream) 401, which may correspond to the output 311 generated by the compression process described with reference to FIG. 3. The compressed file 401 may contain encoded Gaussian splat data along with metadata including source camera parameters associated with the source camera(s) 104 that captured the original scene.

The method proceeds to step 402, which involves decompressing the compressed bitstream file 401. During step 402, the compressed Gaussian splat data is decoded to reconstruct the Gaussian splat parameters. The decompression mechanism used in step 402 may be the inverse of the compression mechanism used in step 305. For example, if lossless compression was used during encoding, step 402 may apply lossless decompression to recover bit-exact copies of the original Gaussian splat parameters. If lossy compression was used during encoding, step 402 may apply lossy decompression, and one or more parameters may differ from the original values.

With continued reference to FIG. 4, the decompression process in step 402 may support partial decompression for scalability. The Gaussian splat representation may support scalable bitstreams where partial decompression yields reduced quality levels. According to the desired quality, the bitstream can be decoded in a scalable order. To facilitate decoding and/or reduce the memory used by the decoded scene, the decoded data can be limited to a low scalability level. At a low scalability level, high-order spherical harmonics and/or rotation parameters may not be decoded, and the splats may be represented by circles of uniform colors. By increasing the scalability level, both rotation and/or spherical harmonics can be decoded, making the scene more photorealistic, with each splat represented by an ellipse shape and/or whose color varies depending on the viewpoint.

The Gaussian splat representation may support viewpoint-based streaming where only splats relevant to the viewpoint are transmitted and/or decoded. In such a scenario, information pertaining to those splats may be conveyed and/or rendered that is relevant to the viewpoint. Since each Gaussian is at a specific position in three-dimensional space and has a spatial extent, a streaming and/or decoding system can infer its potential visibility from a restricted set of viewpoints using simple geometric checks, such as frustum elimination, occlusion heuristics, and/or pre-computed visibility cones based on known viewer trajectories. If the decoder knows the range and/or direction of allowed viewpoints (e.g., front-facing only and/or within a navigation lane), the decoder can ignore and/or avoid transmitting Gaussians that fall outside these view cones.

Step 402 produces decompressed Gaussian splat data 404, which may be stored for subsequent processing. The decompressed Gaussian splat data 404 may be stored in memory and/or in a file format such as a PLY file and/or other suitable format. When lossless compression is used, the parameters in the decompressed Gaussian splat data 404 are the same as the output of the training process in step 304. With lossy compression, one or more parameters may be different. However, even with lossy compression, in some cases the decompression process can be bit-exact in that decompression of a given bitstream will yield the same Gaussian splat parameters regardless of decoder implementation.

Following step 402, the method proceeds to step 403, which involves rendering the decompressed Gaussian splat data 404. During step 403, the Gaussian splats are projected and/or blended to generate a rendered image. The rendering process in step 403 may be dependent on the rendering device. Step 403 may render to a conventional two-dimensional raster display as may be available in smartphones, tablets, laptops, and/or TVs. Step 403 may render to immersive display devices such as AR/VR goggles. Step 403 may render to holographic display units. Rendering on two-dimensional displays may require the selection of a viewpoint by the user, as the scene could be viewed from many angles and/or distances.

During step 403, the three-dimensional Gaussians may be accumulated to produce smooth and/or photorealistic images with smooth blending and/or natural occlusions. Some and/or all three-dimensional Gaussians may be projected in order onto the screen according to their parameters. A blending process may be used to mix the contribution of each Gaussian and obtain the rasterized image according to the position of the viewer.

Step 403 may interpret Gaussian splat parameters based on source camera parameters parsed from the decompressed Gaussian splat data 404. The parsing module 224 may extract source camera parameters from the decompressed data. Source camera parameters may include focal length, exposure time, aperture, ISO speed rating, image width, and/or image height. The reconstruction module 226 may adjust Gaussian splat parameters based on a ratio of view camera parameters to source camera parameters. For example, a scale value of a Gaussian splat may be adjusted based on a ratio of a view camera focal length to a source camera focal length. A Jacobian matrix associated with a Gaussian splat may be adjusted based on a ratio of a view camera focal length to a source camera focal length. A covariance matrix of a Gaussian splat may be adjusted based on a squared ratio of a view camera focal length to a source camera focal length. The Jacobian may be computed as:

$$Equation 4$$

$$J = \frac{\partial ( x , y )}{\partial ( X , Y , Z )} = [ \begin{matrix}\frac{\partial x}{\partial X} & \frac{\partial x}{\partial Y} & \frac{\partial x}{\partial Z} \\ \frac{\partial y}{\partial X} & \frac{\partial y}{\partial Y} & \frac{\partial y}{\partial Z}\end{matrix} ] = [ \begin{matrix}\frac{{f}_{x}}{Z} & 0 & - {f}_{x} \cdot \frac{X}{{Z}^{2}} \\ 0 & \frac{{f}_{x}}{Z} & - {f}_{y} \cdot \frac{Y}{{Z}^{2}}\end{matrix} ]$$

where (X,Y,Z) are the 3D coordinates of a splat in camera space, (fₓ, f_{y}) are focal lengths in pixels (horizontal and vertical), and (x, y) are projected 2D coordinates in the image plane. The Jacobian used to train the sequence may be referred to as Jₜᵣₐᵢₙ and the Jacobian used to render the scene may be referred to as J_{view}.

It may not be possible to render the current scene with Jₜᵣₐᵢₙ, as was done during training because the projection may not be correct based on the 3D environment and may create display inconsistencies. The 3D renderer projects the scene using J_{view}, but the size and the shape of the 3D Gaussian splats can change. To reduce these artifacts, a correction may be used to the focal ratio of the Jacobian matrix as follows:

$${J}_{adjusted} = ( \frac{{f}_{v i e w}}{{f}_{train}} ) \cdot {J}_{view} \qquad Equation 5$$

The same ratio can be applied directly to the covariance matrix:

$${\sum }_{3 {D}_{adjusted}} = {\sum }_{3 D} \cdot {( \frac{{f}_{v i e w}}{{f}_{train}} )}^{2} \qquad Equation 6$$

This approach may change the shape of the 3D splats and may create better results than the others approaches, but may be computationally more complex.

After the step 403 completes, the method may return to process subsequent frames and/or scenes. The flowchart illustrates a processing pipeline where compressed Gaussian splat data flows through decompression and rendering stages, with the decompressed Gaussian splat data 404 serving as an intermediate representation between these stages. The rendering process may be performed in real-time and/or may be performed offline for later playback.

A “user position,” as used herein, may in some cases be associated with the physical position of a human user. More often, however, the term “user position” may relate to the viewpoint from which the 3D scene is being viewed on a display. The user viewing position may be manipulated by the user through a user interface. For example, the human user may manipulate the position through a mouse, trackpad, joystick, and/or similar means. The viewing position may, for example, be moved towards or away from the scene, and/or around the scene in one or more dimensions. On the screen, that activity may appear as if the scene were moved closer to or farther away from the user, and/or being rotated. In some embodiments, the viewspace is restricted, and the human user may be restricted from moving the virtual viewpoint outside of the allowed viewspace, to avoid degraded user experience due to lack of Gaussian splat data that may occur when the viewpoint moves outside the restricted viewspace. In some embodiments, visible artifacts may occur when the viewpoint moves approximately 10 degrees in angle or twice the distance from the source camera positions.

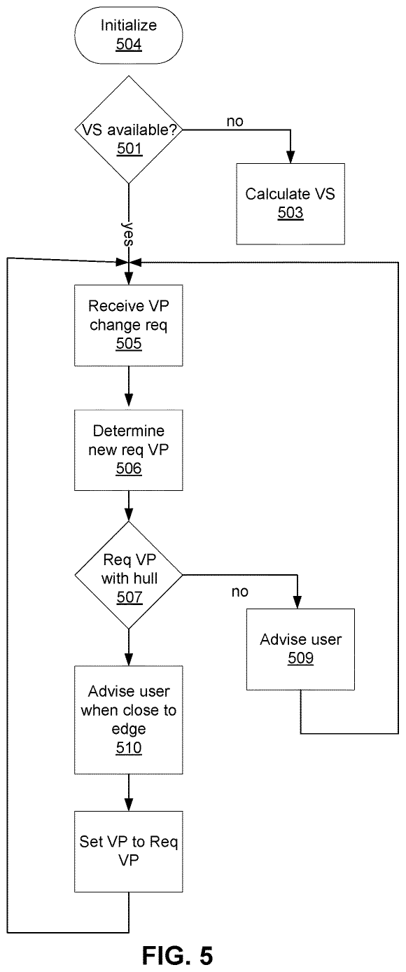

Referring to FIG. 5, a method for analyzing viewpoints is illustrated in accordance with some embodiments. The method may be performed by the decoding module 222 and/or the reconstruction module 226 of the computing system 200. The method begins with step 504, where the system performs initialization. Step 504 may initialize data structures, load Gaussian splat data from the decompressed Gaussian splat data 404, and/or prepare the rendering environment for viewpoint analysis.

Following step 504, the method proceeds to step 501, where the system determines whether a viewspace (VS) is available. The viewspace may define the allowed viewing positions from which the Gaussian splat scene can be rendered with acceptable quality. The viewspace may be pre-computed and/or stored in the compressed bitstream file 401 along with the Gaussian splat data. The viewspace may be defined by one and/or more convex hulls generated from source camera positions associated with the source camera(s) 104. If the viewspace is available (yes branch from step 501), the method proceeds to step 505. If the viewspace is not available (no branch from step 501), the method proceeds to step 503.

In step 503, the system calculates the viewspace. Step 503 may generate one and/or more convex hulls from the source camera positions. The convex hull generation may use the positions of the source camera(s) 104 as vertices. The convex hulls defining the allowed viewspace may be dilated by uniformly scaling vertices outward from the geometric center. Dilation may expand the allowed viewing region beyond the exact positions of the source cameras to provide additional viewing flexibility. The dilation factor may be configurable and/or may depend on the characteristics of the captured scene.

With continued reference to FIG. 5, in step 505, the system receives a viewpoint (VP) change request. The viewpoint change request may be received from user input via the input device(s) 210. The viewpoint change request may specify a new position and/or orientation from which the user desires to view the Gaussian splat scene. The viewpoint change request may be generated by mouse movement, keyboard input, touch gestures, head tracking in VR/AR applications, and/or other input mechanisms.

Following step 505, the method proceeds to step 506, where the system determines a new requested viewpoint. Step 506 may translate the user input received in step 505 into a three-dimensional position and/or orientation within the scene coordinate system. Step 506 may apply any user interface transformations, sensitivity settings, and/or navigation constraints to compute the requested viewpoint.

Following step 506, the method proceeds to step 507, where the system checks whether the requested viewpoint is within the hull. Step 507 may perform geometric intersection tests to determine whether the requested viewpoint lies within the convex hull(s) defining the allowed viewspace. The intersection test may use point-in-polyhedron algorithms and/or other geometric containment tests. If the requested viewpoint is within the hull (yes branch from step 507), the method proceeds to step 510. If the requested viewpoint is not within the hull (no branch from step 507), the method proceeds to step 509.

In step 509, the system advises the user that the requested viewpoint is outside the allowed bounds. The renderer may provide visual, audible, and/or tactile feedback when a user attempts to move outside the allowed viewspace. Visual feedback may include displaying a warning indicator, changing the color of the viewport border, and/or rendering a visual representation of the viewspace boundary. Audible feedback may include playing a warning tone and/or audio cue. Tactile feedback may include vibration and/or haptic response through compatible input devices such as game controllers and/or VR controllers. The renderer may restrict user viewpoint positions to lie within the allowed viewspace defined by convex hulls. The restriction may prevent the viewpoint from moving outside the allowed region and/or may clamp the viewpoint to the nearest point on the boundary.

The renderer may implement a redirection process that projects the user's movement vector onto the tangent of the viewspace boundary. The redirection process may allow the user to continue navigating along the boundary surface rather than being stopped abruptly. The projection may compute the component of the user's intended movement that is parallel to the boundary and/or apply that component to the viewpoint position. The redirection process may provide smooth navigation behavior when the user reaches the edge of the allowed viewspace.

In some embodiments, a redirection process is used to limit disruption and allow the user to continue browsing without stopping and going back. The redirection may be used to guide the user along the boundary of a defined zone by smoothly adjusting the trajectory. When the user's position approaches the edge, their intended movement vector v may be projected onto the tangent t of the border using the formula:

$${v}_{p} = ( v \cdot \frac{t}{{‖ t ‖}^{2}} ) \cdot t \qquad Equation 7$$

The projected vector vₚ represents the direction that slides along the edge. To ensure a natural transition, the final movement direction v′ is computed using linear interpolation:

v′=(1−α)·v+a·vₚ Equation 8

where α∈[0,1] increases as the user gets closer to the border. This approach may maintain smooth navigation while gently redirecting the user, preventing abrupt stops and/or disorienting feedback.

With continued reference to FIG. 5, in the step 510, the system advises the user when close to the edge of the allowed viewspace. The step 510 may be reached when the requested viewpoint is within the hull but approaches the boundary. The renderer may reduce user interface sensitivity when the viewpoint approaches the edge of the allowed viewspace. Sensitivity reduction may slow the rate of viewpoint movement as the viewpoint nears the boundary, providing a gradual transition rather than an abrupt stop. The sensitivity reduction may be proportional to the distance from the boundary, with greater reduction as the viewpoint approaches closer to the edge.

The step 510 may provide feedback to indicate proximity to the boundary. The feedback may be visual (e.g., a gradient overlay and/or boundary indicator), audible (e.g., a proximity tone that increases in intensity), and/or tactile (e.g., increasing vibration intensity). The feedback may help the user understand the extent of the allowed viewing region and/or navigate within the bounds.

Following the step 510, the method sets the viewpoint to the requested viewpoint. The renderer may then render the Gaussian splat scene from the new viewpoint position. The method may return to the step 505 to receive subsequent viewpoint change requests, enabling continuous navigation within the allowed viewspace.

The renderer may provide keyboard shortcuts to jump to preferred viewing positions corresponding to source camera positions. The preferred viewing positions may correspond to the positions of the source camera(s) 104 used during capture. Jumping to source camera positions may provide viewpoints from which the Gaussian splat scene was directly trained, potentially offering higher rendering quality. The keyboard shortcuts may be configurable and/or may cycle through available source camera positions in sequence.

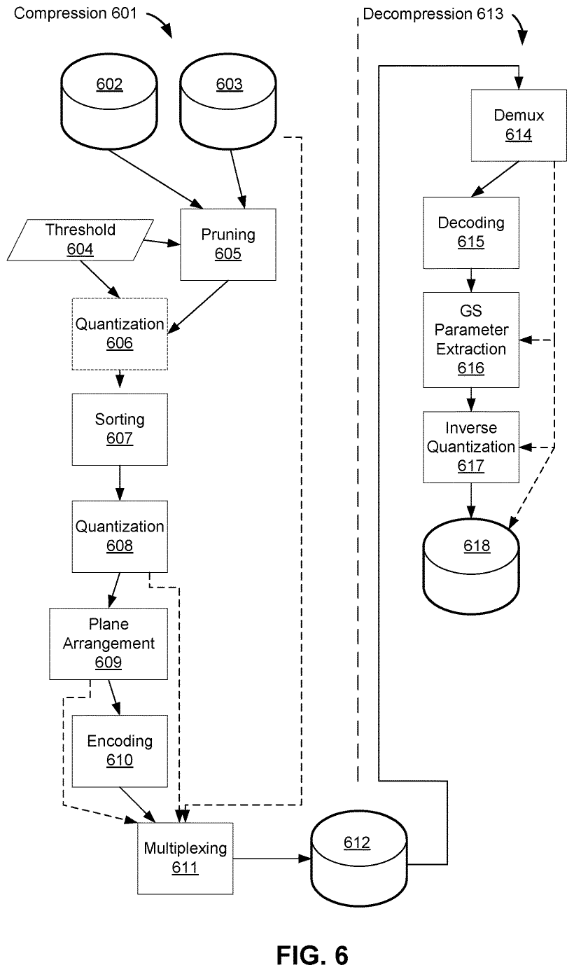

Referring to FIG. 6, a method for compressing and decompressing Gaussian splats is illustrated in accordance with some embodiments. The method includes a compression 601 portion and a decompression 613 portion. The compression 601 portion may be performed by the encoding module 240 of the computing system 200. The decompression 613 portion may be performed by the decoding module 222 of the computing system 200.

The compression 601 portion receives input from a database 602 and a database 603. The database 602 may store Gaussian splat data including position coordinates, rotation quaternions, scale vectors, color vectors, opacity values, and/or spherical harmonics coefficients for each Gaussian splat in the scene. The database 603 may store associated metadata including source camera parameters, viewpoint restrictions, and/or other auxiliary information associated with the Gaussian splat representation. The database 602 and/or the database 603 may correspond to the output 311 generated by the training process described with reference to FIG. 3 prior to compression. In some embodiments, the database 602 and the database 603 are the same database.

A threshold 604 provides parameters that control subsequent processing steps in the compression 601 portion. The threshold 604 may specify values for pruning criteria, quantization parameters, and/or other configurable aspects of the compression process. The threshold 604 may be user-configurable and/or may be determined automatically based on target bitrate, quality level, and/or storage constraints.

With continued reference to FIG. 6, the compression 601 portion includes a pruning 605 step that receives data from the database 603 and is controlled by the threshold 604. The pruning 605 step may remove Gaussian splats and/or portions thereof based on criteria specified by the threshold 604. The pruning 605 step may remove Gaussian splats that are hidden from observation from any allowed viewspace defined in the database 603. The pruning 605 step may remove Gaussian splats based on their size, where splats below a size threshold are removed. The pruning 605 step may remove Gaussian splats based on distance from scene origin and/or distance from the allowed viewspace. The pruning 605 step may remove high-order spherical harmonics parameters from individual Gaussian splats rather than removing entire splats, thereby reducing data volume while preserving the spatial distribution of splats. The pruning 605 step may use viewpoint-based criteria where splats that fall outside view cones defined by allowed viewpoints are removed. The pruning 605 step may use opacity-based criteria where splats with opacity values below a threshold are removed. The pruning 605 step may use contribution-based criteria where splats whose contribution to rendered images is negligible are removed.

Following the pruning 605 step, the compression 601 portion includes an optional quantization 606 step, as indicated by the dashed outline in FIG. 6. The quantization 606 step may perform preliminary quantization of Gaussian splat parameters prior to sorting. The quantization 606 step may reduce the precision of floating point values to facilitate subsequent sorting and/or compression operations. The quantization 606 step may be omitted in some implementations where quantization is performed only after sorting.

The compression 601 portion includes a sorting 607 step that rearranges Gaussian splat parameters to improve compression efficiency. The sorting 607 step may group similar values together to exploit spatial and/or statistical redundancies during subsequent encoding. The sorting 607 step may use a neural network to arrange Gaussian splat parameters into planes suitable for image compression. The neural network may be trained to minimize reconstruction error and/or maximize compression ratio. The sorting 607 step may use other sorting algorithms including Morton code ordering, Hilbert curve ordering, and/or k-d tree based ordering. The sorting 607 step may sort Gaussian splats based on their three-dimensional positions to group spatially proximate splats together. The sorting 607 step may sort Gaussian splat parameters based on their values to group similar parameter values together within each plane.

With continued reference to FIG. 6, following the sorting 607 step, the compression 601 portion includes a quantization 608 step that converts floating point values to fixed-length formats suitable for image and/or video compression. The quantization 608 step is controlled by the threshold 604, which may specify quantization step sizes, bit depths, and/or other quantization parameters. The quantization 608 step may use linear mapping to convert floating point values to fixed-bit integers, where the mapping applies a uniform scale factor across the value range. The quantization 608 step may use piecewise linear mapping to convert floating point values to fixed-bit integers, where different scale factors are applied to different portions of the value range. The quantization 608 step may use logarithmic mapping to convert floating point values to fixed-bit integers, where the mapping applies a logarithmic transformation to compress the dynamic range. The quantization 608 step may use quantization matrices similar to those used in MPEG-2 for non-uniform value mapping, where different quantization step sizes are applied based on the position and/or type of the value being quantized. Different quantization mechanisms may be used for different Gaussian splat parameter types. For example, position coordinates may use linear quantization with high precision, spherical harmonics coefficients may use logarithmic quantization to handle their wide dynamic range, and/or opacity values may use piecewise linear quantization to preserve perceptually relevant distinctions.

Following the quantization 608 step, the compression 601 portion includes a plane arrangement 609 step that organizes the quantized Gaussian splat parameters into two-dimensional planes of samples. The plane arrangement 609 step generates metadata indicated by dashed arrows in FIG. 6, which describes the arrangement of parameters within the planes and/or enables reconstruction during decompression. The plane arrangement 609 step may place Gaussian splat parameters into images using a 4:4:4 sampling structure with RGB components, where each color component carries a different parameter type and/or a different portion of the same parameter type. The plane arrangement 609 step may group parameters of the same type into the same image plane, such that all position coordinates are in one set of planes, all rotation quaternions are in another set of planes, and/or all spherical harmonics coefficients are in yet another set of planes. The plane arrangement 609 step may place higher importance parameters in the Y component and lower importance parameters in Cr and Cb components when using a YCbCr color space, thereby allowing the encoding step to allocate more bits to perceptually relevant parameters. The plane arrangement 609 step may arrange spherical harmonics planes such that they can be fed into a video codec to exploit inter-picture redundancies among the multiple spherical harmonics coefficients associated with each Gaussian splat.

With continued reference to FIG. 6, following the plane arrangement 609 step, the compression 601 portion includes an encoding 610 step that compresses the arranged planes using image and/or video compression mechanisms. The encoding 610 step may use image compression techniques such as JPEG and/or HEIF for still Gaussian splat data representing static scenes. The encoding 610 step may use video compression techniques such as HEVC, VVC, and/or AV1 for time-variant Gaussian splat sequences representing dynamic scenes and/or for exploiting redundancies among multiple parameter planes. The encoding 610 step may apply different compression techniques to different parameter types based on their statistical characteristics and/or perceptual relevance. The encoding 610 step may use lossless compression for parameters where exact reconstruction is desired and/or lossy compression for parameters where some degradation is acceptable.

Following the encoding 610 step, the compression 601 portion includes a multiplexing 611 step that combines the encoded data with metadata from the plane arrangement 609 step, the quantization 608 step, and/or the database 603. The multiplexing 611 step may interleave the encoded parameter planes with the metadata to produce a single compressed output stream. The multiplexing 611 step may organize the compressed data into a format suitable for streaming and/or random access. The multiplexing 611 step may include synchronization information to enable parallel decoding of multiple parameter planes.

The output of the multiplexing 611 step is stored in a storage 612. The storage 612 may correspond to the compressed file 401 described with reference to FIG. 4. The storage 612 may be a file on a local storage device, a file on a network-accessible storage system, and/or a buffer for real-time transmission. The data stored in the storage 612 may be transmitted through the network(s) 110 to the electronic device 120-1 and/or other electronic devices for decompression and rendering.

Referring again to FIG. 6, the decompression 613 portion begins by retrieving data from the storage 612 (or receiving a bitstream). The decompression 613 portion includes a demux 614 step that separates the multiplexed data into encoded streams and metadata. The demux 614 step may parse the compressed bitstream to identify the boundaries between encoded parameter planes and/or metadata sections. The demux 614 step may extract synchronization information to enable parallel decoding of multiple parameter planes. The demux 614 step may extract source camera parameters and/or viewpoint restriction information from the metadata for use during rendering.

Following the demux 614 step, the decompression 613 portion includes a decoding 615 step that reconstructs the image and/or video data from the encoded streams. The decoding 615 step may apply the inverse of the encoding operations performed in the encoding 610 step. The decoding 615 step may use image decompression techniques such as JPEG decoding and/or HEIF decoding for still Gaussian splat data. The decoding 615 step may use video decompression techniques such as HEVC decoding, VVC decoding, and/or AV1 decoding for time-variant Gaussian splat sequences and/or for parameter planes encoded using video codecs.

With continued reference to FIG. 6, following the decoding 615 step, the decompression 613 portion includes a GS parameter extraction 616 step that recreates the list of Gaussian splat parameters from the decoded planes. The GS parameter extraction 616 step is controlled by metadata from the demux 614 step, which describes the arrangement of parameters within the planes. The GS parameter extraction 616 step may reverse the plane arrangement performed in the plane arrangement 609 step to recover individual Gaussian splat parameters from the two-dimensional planes. The GS parameter extraction 616 step may reverse the sorting performed in the sorting 607 step to restore the original ordering of Gaussian splats.

Following the GS parameter extraction 616 step, the decompression 613 portion includes an inverse quantization 617 step that converts the quantized values back to floating point format. The inverse quantization 617 step is controlled by metadata from the demux 614 step, which specifies the quantization parameters used during compression. The inverse quantization 617 step may apply the inverse of the linear, piecewise linear, and/or logarithmic mapping used in the quantization 608 step. The inverse quantization 617 step may include smoothing operations beyond simple multiplication to reduce quantization artifacts. The inverse quantization 617 step may include temporal smoothing operations for time-variant Gaussian splat sequences to reduce flickering and/or temporal discontinuities caused by quantization. The inverse quantization 617 step may apply different inverse quantization mechanisms for different Gaussian splat parameter types corresponding to the different quantization mechanisms used during compression.

The resulting decompressed Gaussian splat data is stored in a storage 618 and/or forwarded to a renderer. The storage 618 may correspond to the decompressed Gaussian splat data 404 described with reference to FIG. 4. The storage 618 may be a memory buffer for immediate rendering and/or a file for later use. The data stored in the storage 618 may be rendered using the rendering process described with reference to the step 403 of FIG. 4, where Gaussian splat parameters may be interpreted based on source camera parameters extracted during the demux 614 step.

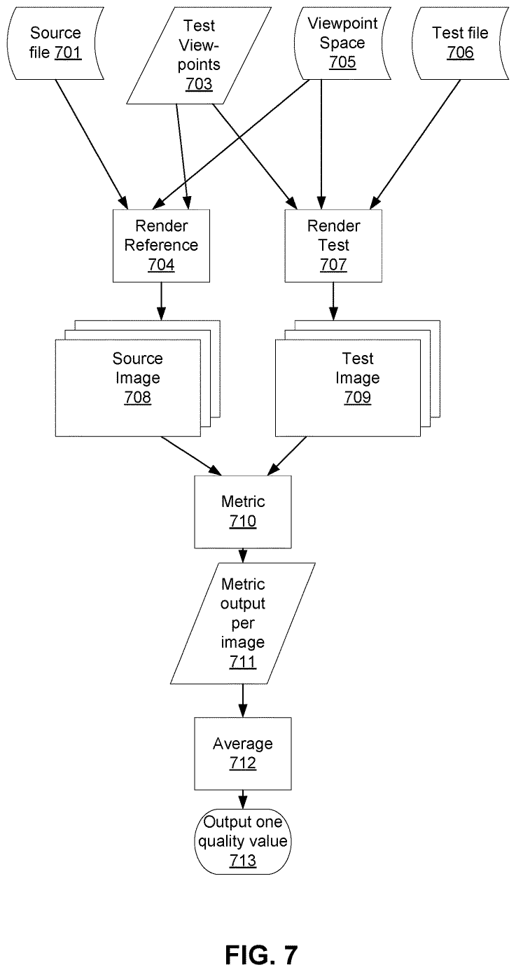

Referring to FIG. 7, a method for analyzing compression outputs for Gaussian splat data is illustrated in accordance with some embodiments. The method may be performed by the assessment module 228 of the decoding module 222 and/or the assessment module 244 of the encoding module 240 of the computing system 200. The method involves comparing a source file 701 against a test file 706 using multiple test viewpoints 703 within a viewpoint space 705. The source file 701 may contain uncompressed and/or reference Gaussian splat data representing the original scene prior to compression. The test file 706 may contain compressed and/or reconstructed Gaussian splat data that has been processed through the compression 601 and/or decompression 613 portions described with reference to FIG. 6. The viewpoint space 705 may define the allowed viewing positions from which the Gaussian splat scene can be rendered, and may correspond to the viewspace calculated in the step 503 and/or stored in the database 603.

With continued reference to FIG. 7, the source file 701 and the test viewpoints 703 are provided to a render reference 704 operation. The render reference 704 operation renders the Gaussian splat data from the source file 701 at each of the test viewpoints 703 to generate a source image 708. The source image 708 represents the reference rendering quality that would be achieved using the uncompressed and/or original Gaussian splat data. The render reference 704 operation may use the rendering process described with reference to the step 403 of FIG. 4, where Gaussian splat parameters are projected and/or blended to generate rendered images.

Similarly, the test file 706, the test viewpoints 703, and the viewpoint space 705 are provided to a render test 707 operation. The render test 707 operation renders the Gaussian splat data from the test file 706 at each of the test viewpoints 703 to generate a test image 709. The test image 709 represents the rendering quality achieved using the compressed and/or reconstructed Gaussian splat data. The render test 707 operation may use the same rendering process as the render reference 704 operation, e.g., to ensure consistent comparison conditions.

The source image 708 and the test image 709 are then provided to a metric 710 operation. The metric 710 operation compares the rendered images to quantify the difference between the reference rendering and the test rendering. The metric 710 operation may compute Peak Signal-to-Noise Ratio (PSNR) between corresponding source and test images. PSNR may be computed as a logarithmic measure of the ratio between the maximum possible signal power and the power of the distortion (noise) affecting the signal quality. The metric 710 operation may compute Mean Squared Error (MSE) between corresponding source and test images. MSE may be computed as the average of the squared differences between corresponding pixel values in the source and test images. The metric 710 operation may compute other image quality metrics including Structural Similarity Index (SSIM), Multi-Scale SSIM, and/or perceptual quality metrics based on neural network features.

With continued reference to FIG. 7, the metric 710 operation produces a metric output per image 711 for each pair of rendered images corresponding to the test viewpoints 703. The metric output per image 711 may include a PSNR value, an MSE value, and/or other quality metric values for each test viewpoint. The number of metric output per image 711 values corresponds to the number of test viewpoints 703 used in the quality assessment.

The metric output per image 711 values are then provided to an average 712 operation. The average 712 operation combines the individual metric outputs to produce a single quality measure. The average 712 operation may compute an arithmetic mean of the metric output per image 711 values. The average 712 operation may compute a weighted average of the metric output per image 711 values, where different weights are assigned to different viewpoints based on their location within the viewpoint space 705. Viewpoints that are inside the allowed viewspace may be assigned higher weights than viewpoints that are outside the allowed viewspace, reflecting the greater perceptual relevance of rendering quality within the intended viewing region. Viewpoints near the center of the allowed viewspace may be assigned higher weights than viewpoints near the boundary, reflecting the expectation that users may spend more time viewing from central positions. The average 712 operation may compute a geometric mean and/or harmonic mean of the metric output per image 711 values as alternatives to arithmetic averaging. In some embodiments, non-averaging methods are used to combine the metric output per image 711 values, such as selecting a minimum value, selecting a maximum value, computing a median, and/or computing a percentile value (e.g., the 5th percentile or 95th percentile).

The average 712 operation produces an output one quality value 713, which represents an overall quality assessment of the test file 706 relative to the source file 701. The output one quality value 713 may be used to evaluate the effectiveness of compression algorithms, compare different compression settings, and/or determine whether the compressed Gaussian splat data meets quality requirements for a given application. The output one quality value 713 may be expressed in decibels (dB) when PSNR is used as the underlying metric, and/or may be expressed as a dimensionless ratio and/or percentage for other metrics.

The test viewpoints 703 may be generated using various methods. The test viewpoints 703 may be automatically generated using the Fibonacci method for uniform distribution on a sphere. The Fibonacci sphere sampling method may place viewpoints at positions corresponding to the golden angle spiral on a sphere, providing approximately uniform angular spacing between viewpoints. The Fibonacci method may generate N viewpoints by computing spherical coordinates based on the golden ratio, where each successive viewpoint is offset by the golden angle (approximately 137.5 degrees) in azimuth and distributed uniformly in the vertical direction. The test viewpoints 703 may be generated using random selection, where viewpoint positions are sampled randomly from the viewpoint space 705. Random selection may provide statistical coverage of the viewpoint space without the computational overhead of computing uniform distributions. The test viewpoints 703 may be generated using uniform angular spacing in spherical coordinates, where viewpoints are placed at regular intervals in azimuth and/or elevation angles. The test viewpoints 703 may be generated using stratified sampling, where the viewpoint space 705 is divided into regions and one and/or more viewpoints are sampled from each region.

The number of test viewpoints 703 may vary based on computational resources and/or desired accuracy. A larger number of test viewpoints 703 may provide more accurate quality assessment at the cost of increased computation time for rendering and/or metric calculation. A smaller number of test viewpoints 703 may provide faster quality assessment with reduced accuracy. The number of test viewpoints 703 may be configurable and/or may be determined automatically based on available computational resources, time constraints, and/or the complexity of the Gaussian splat scene. The number of test viewpoints 703 may range from a few viewpoints for rapid quality estimation to hundreds and/or thousands of viewpoints for comprehensive quality assessment.

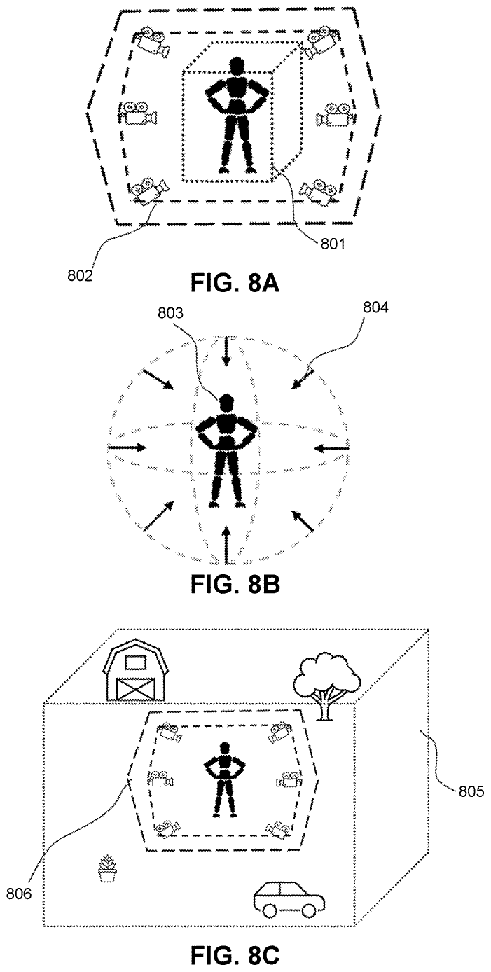

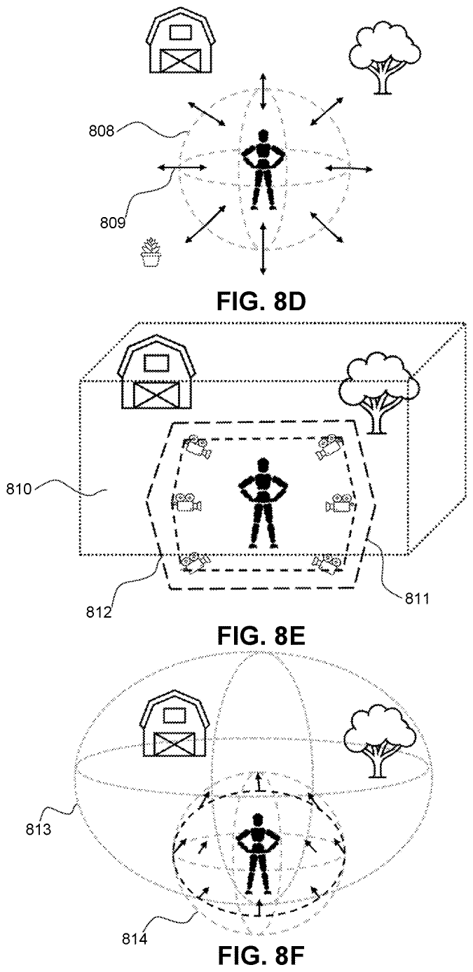

Referring to FIG. 8A, a convex hull intersection 801 on a sphere is illustrated in accordance with some embodiments. The convex hull intersection 801 represents a region on the surface of a sphere that is bounded by the edges of a convex hull formed from selected points on the sphere. An outer boundary 802 defines the perimeter of the convex hull intersection 801, delineating the allowed viewing space on the spherical surface. The convex hull intersection 801 and the outer boundary 802 together illustrate how viewing positions can be constrained to a specific region of a sphere. The allowed viewspace may be defined by a convex hull intersection on a sphere surface, where the intersection is the part of the sphere that is cut and/or bounded by the edges of the convex hull of chosen points on the sphere. In this case, the allowed viewspace may be defined by n+1 values, with n being the number of points of the convex hull. The convex hull intersection 801 may be specified using spherical coordinates, where each point on the convex hull is defined by theta and phi angles relative to a center point and radius of the sphere.

With continued reference to FIG. 8A, the convex hull intersection 801 may be used for determining test viewpoints and/or allowed viewing spaces in Gaussian splat rendering applications. The outer boundary 802 may correspond to the positions of the source camera(s) 104 used during capture, such that the allowed viewing region encompasses the positions from which the scene was originally captured. The convex hull intersection 801 may be dilated by uniformly scaling vertices outward from the geometric center to expand the allowed viewing region beyond the exact positions of the source cameras. The convex hull intersection 801 may be stored in the compressed bitstream file 401 along with the Gaussian splat data, enabling the decoder 122 and/or the reconstruction module 226 to determine allowed viewing positions during rendering.

Referring to FIG. 8B, an allowed viewing space 804 surrounding a human FIG. 803 is illustrated in accordance with some embodiments. The human FIG. 803 is positioned at the center of the illustration. The allowed viewing space 804 is represented by dashed lines forming a spherical boundary around the human FIG. 803. Multiple arrows point inward toward the human FIG. 803 from various directions around the allowed viewing space 804, indicating viewing directions from positions on the boundary of the allowed viewing space 804. The arrows are distributed at regular intervals around the spherical boundary, including positions at the top, bottom, left, right, and/or diagonal orientations, representing potential viewpoints from which the scene containing the human FIG. 803 may be rendered.

With continued reference to FIG. 8B, when the scene is inside the convex hull, virtual cameras may be placed equidistantly on a sphere containing the scene pointing toward the center. The arrows in FIG. 8B illustrate this configuration, where viewing positions are distributed around the allowed viewing space 804 with viewing directions oriented toward the human FIG. 803 at the center. The equidistant placement of virtual cameras may be achieved using the Fibonacci sphere sampling method described with reference to FIG. 7, and/or using uniform angular spacing in spherical coordinates. The allowed viewing space 804 may correspond to the viewpoint space 705 used in the quality assessment method described with reference to FIG. 7.

The allowed viewspace may be defined using various representations and/or methods. The allowed viewspace may be defined by a three-dimensional bounding box specified by two corner points. The bounding box may be defined by a lower/left/back point and an upper/right/forward point of a box, such that any position within the three-dimensional bounding box may be a suitable viewing position. A file may include more than one three-dimensional bounding box, and in that case all volume within each of the boxes may be a suitable viewing position. Bounding boxes may also be used to indicate more and/or less suitable and/or recommended viewing positions. For example, a file may include three bounding boxes: a small one with preferred viewing positions, a larger one with viewing positions that may offer good quality, and an even larger one where viewing may still be sensible but artifacts begin to become annoying.

A bounding box may be defined by two points in 3D space, for example the lower/left/back point and the upper/right/forward point of a box. Other geometric figures may be used in a similar manner but may require more data points. Any position within a 3D bounding box may be a suitable viewing position. In some embodiments, a file includes more than one 3D bounding box, and in that case all volume within each of the boxes may be a suitable viewing position. Bounding boxes may also be used to indicate more or less suitable and/or recommended viewing positions. For example, a file may include three bounding boxes: a small one with preferred viewing positions, a larger one with viewing positions that may offer good quality, and an even larger one where viewing may still be acceptable but artifacts may begin to become noticeable. Such granularity may be increased; however, the more granularity is added, the more data needs to be included in the file.

Box=((pₓₘᵢₙ,p_{ymin},p_{zmin}),(Pₓₘₐₓ,p_{ymax},P_{zmax}))

For a planar and/or spherical/semi-spherical rig, an intersection between a sphere and a pyramid may be defined by four values in spherical coordinates based on (θₘᵢₙ, θₘₐₓ) and (φₘᵢₙ, φₘₐₓ) along with the center (x, y, z) the center and R the radius of the sphere. In this case, the space of allowed views can be defined with eight values:

I=(x,y,z,R,θₘᵢₙ,θₘₐₓ,φₘᵢₙ,φₘₐₓ)

The radius R may be stored and/or omitted. When available and stored, the viewspace may be the pyramid defined by the center of the sphere (x, y, z) and the four corner points: (θₘᵢₙ, φₘᵢₙ), (θₘₐₓ, φₘᵢₙ), (θₘᵢₙ, φₘₐₓ) and (θₘₐₓ, φₘₐₓ). Without the radius, the view positions may be defined by the pyramidal cone.

The spherical coordinate representation may be limited by the spherical coordinate system and may not represent a rig oriented in the z direction, in which case the rectangle may be degenerated. In another approach, a square in any direction may be defined based on a center of the sphere, the radius, a quaternion (qₓ, q_{y}, q_{z}, q_{w}) defining the direction of the square according to the center of the sphere and the size of the square (Sₓ, S_{y}):

I=(x,y,z,R,qₓ,q_{y},q_{z},q_{w} Sₓ,S_{y})

The quaternion representation may have the advantage of storing not only the direction but also the rotation around the direction axis and may be easier to manipulate in three-dimensional space.

The allowed viewspace may also be defined by a convex hull intersection on a sphere. Referring to FIG. 8A, the convex hull intersection 801 on a sphere is the part of the sphere that is bounded by the edges of the convex hull of chosen points on the sphere. In this case, the allowed viewspace may be defined by n+1 values, where n is the number of points of the convex hull:

I={x,y,z,R,(θᵢ,φᵢ) with i in {1,2, . . . ,n}}

If six degrees of freedom (6DoF) navigation is desired, a flag may be included indicating that this functionality is allowed. By default, without any value defining the allowed viewing space, unconstrained navigation may be allowed and 6DoF navigation may be possible. In addition to parameters defining the allowed viewing positions, a parameter may define the maximum distance the user can be from these areas. This parameter may allow the content creator to define at which distance from the camera position points the users can be. The maximum distance parameter may be used in conjunction with any of the allowed viewspace representations described above, including the convex hull intersection 801, the three-dimensional bounding box, and/or the sphere-pyramid intersection.

Referring to FIG. 8C, an example scene configuration is illustrated in accordance with some embodiments. FIG. 8C depicts a scene 805 represented by a dashed rectangular boundary containing various objects including a barn, a tree, a potted plant, and/or a car. Within the scene 805, a capture volume 806 is indicated by a dashed inner boundary surrounding a human figure positioned at the center. Multiple cameras are arranged around the human figure within the capture volume 806, with cameras positioned at the corners and/or along the edges of the capture volume 806 to capture the subject from multiple angles. The cameras are oriented to point toward the central human figure. The scene 805 encompasses both the capture volume 806 and the surrounding environmental elements, illustrating a configuration where the capture volume 806 containing the cameras and subject is located inside the broader scene 805.

With continued reference to FIG. 8C, the capture volume 806 may correspond to the positions of the source camera(s) 104 used during capture. The capture volume 806 may define a region within which the cameras are positioned and/or within which the captured subject is located. The relationship between the scene 805 and the capture volume 806 may vary depending on the capture configuration. In the configuration shown in FIG. 8C, the capture volume 806 is inside the scene 805, such that the cameras capture a subject that is surrounded by environmental elements extending beyond the capture volume 806. The capture volume 806 may be defined by a convex hull generated from the camera positions, and/or may be defined by a bounding box, sphere, and/or other geometric shape encompassing the camera positions.

The camera arrangement within the capture volume 806 may vary. The cameras may be arranged in a planar configuration, where all cameras are positioned on a single plane and/or on parallel planes. Planar camera arrangements may be suitable for capturing subjects from a limited range of viewing angles, such as front-facing capture for video conferencing and/or telepresence applications. The cameras may be arranged in a spherical configuration, where cameras are distributed around a sphere surrounding the subject. Spherical camera arrangements may be suitable for capturing subjects from all viewing angles, enabling full 360-degree viewing of the captured scene. The cameras may be arranged in a hemispherical configuration, where cameras are distributed around a hemisphere surrounding the subject. Hemispherical camera arrangements may be suitable for capturing subjects from viewing angles above and/or around the subject while excluding viewing angles from below.

Referring to FIG. 8D, a schematic illustration of viewing directions and spatial boundaries is depicted in accordance with some embodiments. FIG. 8D shows a human figure positioned at the center of a viewing space with multiple directional indicators. The human figure stands at the center of the illustration, surrounded by two concentric dashed circles 809 that represent viewing boundaries and/or spatial regions. Multiple arrows 808 extend outward from the human figure in various directions, including upward, downward, left, right, and/or diagonal orientations, indicating potential viewing directions and/or movement vectors within the viewing space. The arrows 808 point both toward and away from the human figure, suggesting bidirectional viewing and/or navigation capabilities. Surrounding the central viewing space are environmental elements including a barn structure in the upper left region, a tree in the upper right region, and/or a potted plant in the lower left region, which represent objects within a scene that may be captured and/or rendered using Gaussian splat techniques.

With continued reference to FIG. 8D, the dashed circles 809 define spatial boundaries that may correspond to allowed viewing positions and/or convex hull regions. The inner dashed circle of the dashed circles 809 may define a preferred viewing region where rendering quality is highest. The outer dashed circle of the dashed circles 809 may define an extended viewing region where rendering quality may be acceptable but reduced compared to the preferred viewing region. The arrows 808 illustrate that viewing directions may be oriented both inward toward the subject and/or outward away from the subject. When the convex hull is inside the scene 805, virtual cameras may be placed on the edge of the convex hull with both inward and/or outward orientations. Inward-oriented viewing directions may be used to view the captured subject from surrounding positions. Outward-oriented viewing directions may be used to view the surrounding environment from positions near the captured subject.

The bidirectional viewing orientations illustrated by the arrows 808 may be relevant when there is partial intersection between the scene 805 and the convex hull defined by the capture volume 806. When there is partial intersection between the scene 805 and the convex hull, virtual cameras may be placed at the intersection of the convex hull sphere and an object-centered sphere. The intersection region may define viewing positions from which both the captured subject and/or portions of the surrounding environment can be rendered with acceptable quality. The arrows 808 may indicate viewing directions that are valid within the intersection region, with some arrows 808 pointing toward the subject and/or other arrows 808 pointing toward the surrounding environment.

Referring to FIG. 8E, an example scene configuration is illustrated in accordance with some embodiments. FIG. 8E depicts a virtual environment 810 containing a capture subject 812 surrounded by a camera array 811. The virtual environment 810 includes background elements such as a barn and/or a tree. The camera array 811 comprises multiple cameras positioned around the capture subject 812, with the cameras arranged to capture the capture subject 812 from multiple angles. The capture subject 812 is depicted as a human figure standing in a central position within the virtual environment 810. The camera array 811 forms a boundary indicated by dashed lines that defines a capture region around the capture subject 812. An outer boundary indicated by dotted lines represents the extent of the virtual environment 810.

With continued reference to FIG. 8E, the camera array 811 may correspond to the source camera(s) 104 of the source device 102. The camera array 811 may be configured to capture images of the capture subject 812 from multiple viewing angles simultaneously and/or in rapid succession. The positions and/or orientations of the cameras in the camera array 811 may be known a priori from calibration and/or may be determined using structure from motion techniques as described with reference to the step 303 of FIG. 3. The camera array 811 may define a convex hull that encompasses the capture subject 812, such that the capture subject 812 is inside the convex hull formed by the camera positions.

The relationship between the virtual environment 810, the camera array 811, and the capture subject 812 may vary depending on the capture configuration. In the configuration shown in FIG. 8E, the capture subject 812 is inside the convex hull formed by the camera array 811, and the camera array 811 is inside the virtual environment 810. This configuration may be suitable for capturing a subject that can be viewed from surrounding positions, with the surrounding environment providing context and/or background for the captured subject. The virtual environment 810 may extend beyond the camera array 811, such that portions of the virtual environment 810 are outside the convex hull formed by the camera positions. Rendering quality for portions of the virtual environment 810 outside the convex hull may be reduced compared to rendering quality for the capture subject 812 inside the convex hull.

The Gaussian splat file generated from the capture configuration shown in FIG. 8E may include metadata indicating the allowed viewing space and/or navigation capabilities, such as the 6DoF navigation flag and/or maximum distance parameter described above with reference to FIG. 8B. The Gaussian splat file may also include the maximum distance parameter described above, which may be used in conjunction with the convex hull and/or other allowed viewspace representations to define a volumetric region within which viewing is permitted.

Referring to FIG. 8F, an example scene depicting a viewing configuration for Gaussian splat rendering is illustrated in accordance with some embodiments. FIG. 8F shows a human figure positioned at the center of the scene, with an outer viewing region 813 represented by a larger dashed ellipsoid surrounding the scene. An inner viewing region 814 is represented by a smaller dashed sphere positioned closer to the human figure. Arrows extend outward from the human figure in multiple directions, indicating potential viewing directions. The outer viewing region 813 encompasses environmental elements including a barn structure and/or a tree, while the inner viewing region 814 defines a more constrained viewing space around the central subject. The configuration illustrates how viewing regions can be defined at different distances from a captured scene to establish allowed viewpoint boundaries for rendering Gaussian splat data.

With continued reference to FIG. 8F, the inner viewing region 814 and the outer viewing region 813 may define tiered viewpoint boundaries with different quality characteristics and/or navigation permissions. The inner viewing region 814 may correspond to a preferred viewing region where rendering quality is highest due to proximity to the positions of the source camera(s) 104 used during capture. Viewpoints within the inner viewing region 814 may produce rendered images with minimal artifacts and/or high fidelity to the original captured scene. The outer viewing region 813 may correspond to an acceptable viewing region where rendering quality remains satisfactory but may be reduced compared to the inner viewing region 814. Viewpoints within the outer viewing region 813 but outside the inner viewing region 814 may produce rendered images with some visible artifacts and/or reduced detail compared to viewpoints within the inner viewing region 814.

The multi-region viewing configuration shown in FIG. 8F may support multiple quality tiers beyond the two regions illustrated. A Gaussian splat file may include three and/or more viewing regions corresponding to preferred, acceptable, and/or marginal quality tiers. The preferred tier may define viewpoints from which rendering quality is highest and/or most closely matches the original captured scene. The acceptable tier may define viewpoints from which rendering quality is satisfactory for most applications and/or use cases. The marginal tier may define viewpoints from which rendering quality is degraded but may still be usable for certain applications where some artifacts are tolerable. Each quality tier may be associated with a corresponding viewing region, and the viewing regions may be nested such that the preferred region is contained within the acceptable region, which is contained within the marginal region.

The shapes of the inner viewing region 814 and the outer viewing region 813 may vary depending on the capture configuration and/or the characteristics of the captured scene. The viewing regions may be spherical as illustrated in FIG. 8F, where the regions are defined by concentric spheres centered on the captured subject. The viewing regions may be ellipsoidal, where the regions are defined by ellipsoids with different axis lengths to accommodate non-uniform capture configurations. The viewing regions may be defined by convex hulls generated from the positions of the source camera(s) 104, where the inner viewing region 814 corresponds to a convex hull of the camera positions and the outer viewing region 813 corresponds to a dilated version of the convex hull. The viewing regions may be defined by bounding boxes, where the inner viewing region 814 corresponds to a smaller bounding box and the outer viewing region 813 corresponds to a larger bounding box. The viewing regions may be defined by combinations of geometric shapes, such as a spherical inner viewing region 814 combined with a bounding box outer viewing region 813.

The outer viewing region 813 may be associated with the maximum viewing distance parameter described above with reference to FIG. 8B, which defines the outermost boundary of allowed viewpoints. The maximum viewing distance parameter may be used in conjunction with the inner viewing region 814 and the outer viewing region 813 to define a complete specification of the allowed viewing space with quality tier information.

The 6DoF navigation flag described above with reference to FIG. 8B may be used to control allowed movement within the viewing space defined by the inner viewing region 814 and the outer viewing region 813. The 6DoF navigation flag may be associated with different values for different viewing regions. For example, the inner viewing region 814 may have 6DoF navigation enabled, allowing full freedom of movement within the preferred viewing region, while the outer viewing region 813 may have 6DoF navigation disabled and/or restricted, limiting movement to rotation-only navigation and/or navigation along constrained paths. The differentiated navigation permissions may encourage users to remain within the inner viewing region 814 where rendering quality is highest while still permitting limited exploration of the outer viewing region 813.

The renderer may provide visual, audible, and/or tactile feedback to indicate the current quality tier based on the viewpoint position relative to the inner viewing region 814 and the outer viewing region 813. When the viewpoint is within the inner viewing region 814, the renderer may display a first indicator (e.g., a green border and/or icon) to indicate preferred quality. When the viewpoint is within the outer viewing region 813 but outside the inner viewing region 814, the renderer may display a second indicator (e.g., a yellow border and/or icon) to indicate acceptable quality. When the viewpoint approaches the boundary of the outer viewing region 813, the renderer may display a third indicator (e.g., a red border and/or icon) to indicate marginal quality and/or proximity to the viewing boundary. The feedback may help the user understand the extent of the allowed viewing regions and/or navigate within the bounds to achieve desired rendering quality.

The inner viewing region 814 and the outer viewing region 813 may be used in the quality assessment method described with reference to FIG. 7. The test viewpoints 703 may be distributed within the inner viewing region 814, the outer viewing region 813, and/or both regions. The average 712 operation may compute weighted averages where viewpoints within the inner viewing region 814 are assigned higher weights than viewpoints within the outer viewing region 813 but outside the inner viewing region 814. The weighting may reflect the greater perceptual relevance of rendering quality within the preferred viewing region. The output one quality value 713 may be computed separately for each viewing region, providing quality assessments for the preferred tier and/or the acceptable tier. The separate quality assessments may enable content creators and/or compression algorithm developers to evaluate rendering quality at different quality tiers and/or optimize compression parameters for specific quality tier requirements.

Source camera parameters may include general information, camera settings, and/or image settings. General information may include a camera identifier for identifying the camera, which may be useful for capturing Gaussian splat sequences with moving cameras. General information may also include camera manufacturer, camera model, date, and/or timestamp.

Camera settings may include exposure time (duration of exposure), aperture (lens aperture setting), ISO speed ratings (ISO sensitivity), exposure bias (exposure compensation), metering mode (light metering mode such as matrix, center-weighted, and/or spot), flash information (whether the flash was fired or not), focal length (focal length of the lens), lens geometry correction information (lens distortion parameters), lens model (model of the lens used), and/or lens make (manufacturer of the lens). Image settings may include image width (width of the image in pixels), image height (height of the image in pixels), bits per sample (number of bits per color component), color space (color space used such as sRGB and/or AdobeRGB), white balance (white balance setting such as auto and/or manual), saturation (level of color saturation), sharpness (sharpness level), and/or contrast (image contrast setting).

Having introduced several representations and/or value combinations that may represent camera positions, pre-calculated areas that may include allowed, preferred, and/or recommended viewpoints, and/or camera parameters, described below are options for storing those values in file formats. Referring to FIG. 1, the entity that is created, transmitted, and rendered may be a file and/or real-time transmission, such as the encoded bitstream 108 and/or the encoded data 116. In either case, a file format and/or protocol specification may be followed that allows for interoperability. Such a specification may be extended to support the addition of the above data.

File formats that may carry 3D Gaussian splat data include the PLY format described above, certain file formats developed by MPEG that may support SEI messages, and/or stand-alone files in formats such as JSON and/or XML. Described below are additions to the PLY file format. Similar changes may be devised for the other file formats mentioned as well as for certain file formats not introduced herein. To add data to PLY files, three mechanisms are described below. In some embodiments, other mechanisms are used.

A first option may be to place the data in the form of comments, which may be identifiable through keywords that are unlikely to be found in a human-written comment and/or through a well-defined and restricted syntax that allows a parser to differentiate between a human-written comment and the comment-included data. This approach may work with existing, unmodified PLY format parsers, as long as the comments have been consumed by a pre-processor before the parser receives the PLY file. In some embodiments, the comment field, originally intended primarily for human-readable commentary, may include machine-readable data.

A second option may be to use an existing extension mechanism of the base PLY format known as the introduction of one or more new PLY elements. Such elements may be introduced for the data related to the different camera position representations, the different allowed viewpoint representations, and/or other camera data.

A third option may be to use a dedicated metadata file, in formats such as XML, JSON, YAML, and/or using a proprietary text-based syntax, the SEI message syntax, and/or any other suitable syntax, to store source camera position/direction, viewpoint restrictions, and/or camera data. This option may be simpler to implement and to specify, and may leverage format specifications that are more efficient (in terms of, for example, parsing simplicity and/or compactness) than an added PLY element. However, the PLY file, in this case, may not be self-contained, as certain data relevant and/or necessary for proper rendering may be present in a different file. In the case where the 3D Gaussian splat data is a continuous stream capturing a moving scene, synchronization mechanisms may be used. Such mechanisms may include file name conventions (for example, a serial number in the file name that increments with each 3D Gaussian splat frame), timestamp-based synchronization, and/or more advanced mechanisms. In some embodiments, multiple files are handled instead of a single file. For example, if manual copying is involved in a workflow, the metadata file may be inadvertently omitted when the PLY file is copied. Such issues may be alleviated by packing the files together using mechanisms such as .zip and/or tar. Streaming technology typically expects media to be available in a bundled format—often containing multiple representations of various qualities and/or bitrates—in a single file. While those formats, such as ISOBMFF and/or MP4, include sophisticated multiplexing mechanisms, such mechanisms may need to be extended to support a metadata file containing the aforementioned data, and such an extended format may not be universally supported by all streaming servers and clients.

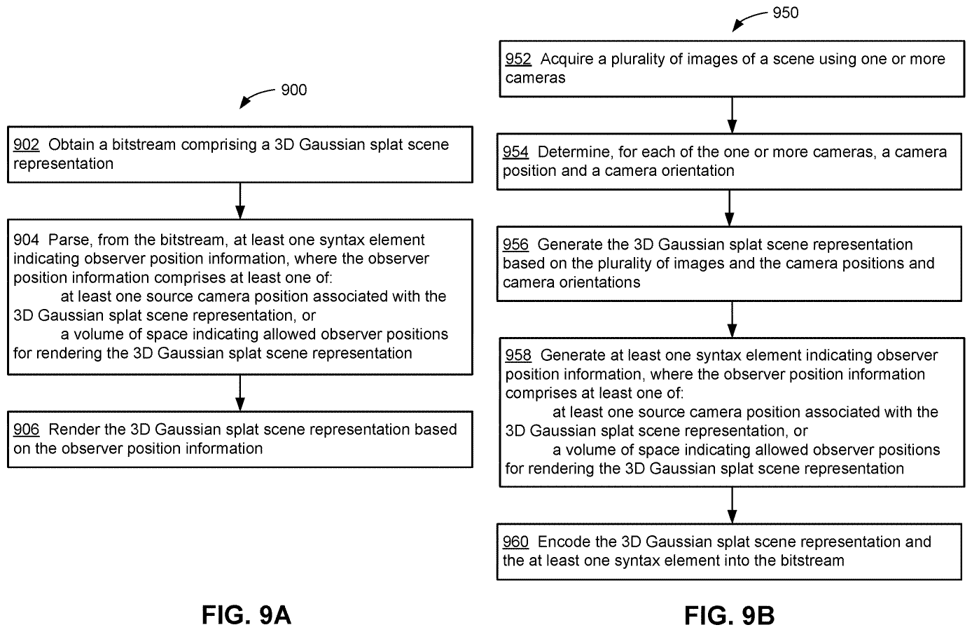

FIG. 9A is a flow diagram illustrating a method 900 of decoding Gaussian splat information in accordance with some embodiments. The method 900 may be performed at a computing system (e.g., the server system 112, the source device 102, or the electronic device 120) having control circuitry and memory storing instructions for execution by the control circuitry. In some embodiments, the method 900 is performed by executing instructions stored in the memory (e.g., the memory 214) of the computing system.

The computing system obtains (902) a bitstream comprising a 3D Gaussian splat scene representation. The computing system parses (904), from the bitstream, at least one syntax element indicating observer position information, where the observer position information comprises at least one of: (i) at least one source camera position associated with the 3D Gaussian splat scene representation, or (ii) a volume of space indicating allowed observer positions for rendering the 3D Gaussian splat scene representation. The computing system renders (906) the 3D Gaussian splat scene representation based on the observer position information.

TABLE 1
below illustrates an example syntax of an SEI message with focus on a
pre-computed information that allows a renderer to determine whether
a certain virtual camera position falls into a suitable range.

| | |
|---|---|
| observer_position_information( payloadSize ) { | |
| opi_persistence_flag | u(1) |
| opi_reset_flag | u(1) |
| opi_6dof_flag | u(1) |
| if( ! opi_6dof_flag ) { | |
| opi_max_distance | f(32) |
| opi_type | u(3) |
| if( opi_type == 0 ) { | |
| opi_camera_id_flag | u(1) |
| opi_direction_flag | u(1) |
| if ( opi_direction_flag ) { | |
| opi_quaternion_direction_flag | u(1) |
| } | |
| opi_num_points | ue(v) |
| for( i = 0; i < opi_num_points; i++ ) { | |
| if ( opi_direction_flag ) { | |
| opi_camera_id[ i ] | u(16) |
| } | |
| opi_point_position_x[ i ] | f(32) |
| opi_point_position_y[ i ] | f(32) |
| opi_point_position_z[ i ] | f(32) |
| if ( opi_direction_flag ) { | |
| opi_point_direction_x[ i ] | f(32) |
| opi_point_direction_y[ i ] | f(32) |
| opi_point_direction_z[ i ] | f(32) |
| if ( opi_quaternon_direction_flag ) { | |
| opi_point_direction_w[ i ] | f(32) |
| } | |
| } | |
| } | |
| } | |
| else if( opi_type == 1 ) { | |
| opi_3d_bounding_box_x | f(32) |
| opi_3d_bounding_box_y | f(32) |
| opi_3d_bounding_box_z | f(32) |
| opi_3d_bounding_box_size_x | f(32) |
| opi_3d_bounding_box_size_y | f(32) |
| opi_3d_bounding_box_size_z | f(32) |
| } | |
| else if( opi_type == 2 ) { | |
| opi_sphere_center_x | f(32) |
| opi_sphere_center_y | f(32) |
| opi_sphere_center_z | f(32) |
| opi_sphere_radius | f(32) |
| opi_sphere_phi_min | f(32) |
| opi_sphere_phi_max | f(32) |
| opi_sphere_theta_min | f(32) |
| opi_sphere_theta_max | f(32) |
| } | |
| else if( opi_type == 3 ) { | |
| opi_sphere_rectangle_center_x | f(32) |
| opi_sphere_rectangle_center_y | f(32) |
| opi_sphere_rectangle_center_z | f(32) |
| opi_sphere_rectangle_radius | f(32) |
| opi_sphere_rectangle_direction_x | f(32) |
| opi_sphere_rectangle_direction_y | f(32) |
| opi_sphere_rectangle_direction_z | f(32) |
| opi_sphere_rectangle_direction_w | f(32) |
| opi_sphere_rectangle_size_x | f(32) |
| opi_sphere_rectangle_size_y | f(32) |
| } | |
| else if( opi_type == 4 ) { | |
| opi_sphere_point_center_x | f(32) |
| opi_sphere_point_center_y | f(32) |
| opi_sphere_point_center_z | f(32) |
| opi_sphere_point_radius | f(32) |
| opi_sphere_num_points | ue(v) |
| for( i = 0; i < opi_sphere_num_points; i++ ) { | |
| opi_sphere_point_theta[ i ] | f(32) |
| opi_sphere_point_phi[ i ] | f(32) |
| } | |
| } | |
| } | |
| } | |

FIG. 9B is a flow diagram illustrating a method 950 of encoding Gaussian splat information in accordance with some embodiments. The method 950 may be performed at a computing system (e.g., the server system 112, the source device 102, or the electronic device 120) having control circuitry and memory storing instructions for execution by the control circuitry. In some embodiments, the method 950 is performed by executing instructions stored in the memory (e.g., the memory 214) of the computing system. In some embodiments, the method 950 is performed by the same computing system as the method 900.

The computing system acquires (952) a plurality of images of a scene using one or more cameras. The computing system determines (954), for each of the one or more cameras, a camera position and a camera orientation. The computing system generates (956) the 3D Gaussian splat scene representation based on the plurality of images and the camera positions and camera orientations. The computing system generates (958) at least one syntax element indicating observer position information, wherein the observer position information comprises at least one of: (i) at least one source camera position associated with the 3D Gaussian splat scene representation, or (ii) a volume of space indicating allowed observer positions for rendering the 3D Gaussian splat scene representation. The computing system encodes (960) the 3D Gaussian splat scene representation and the at least one syntax element into the bitstream.

Although FIGS. 9A and 9B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.
(A1) In one aspect, some embodiments include a method (e.g., the method 900) for processing a three-dimensional (3D) scene representation includes: (i) obtaining a bitstream comprising a 3D Gaussian splat scene representation; (ii) parsing, from the bitstream, at least one syntax element indicating observer position information, wherein the observer position information comprises at least one of: (a) at least one source camera position associated with the 3D Gaussian splat scene representation, or (b) a volume of space indicating allowed observer positions for rendering the 3D Gaussian splat scene representation; and (iii) rendering the 3D Gaussian splat scene representation based on the observer position information. The bitstream may be stored in a file or transmitted directly to a receiver via network transmission using real-time protocols such as RTP, streaming technologies such as DASH, file transfer, or physical transfer using portable memory such as a USB stick. The 3D Gaussian splat scene representation may comprise a sparse point cloud where each point has attributes including position, rotation quaternion, color vector, scale vector, opacity value, and spherical harmonics values. In some embodiments, each 3D Gaussian is defined by a spatial mean and a covariance matrix and is associated with a color and an opacity. The color of each Gaussian may be represented by spherical harmonics to provide view-dependent effects. The 3D Gaussian splat scene representation may be stored in a Polygon File Format (PLY) or other suitable format. In some embodiments, rendering comprises projecting the 3D Gaussians onto an image plane to form 2D Gaussian splats, which are sorted from front to back and alpha-blended for each pixel. The display may comprise a 2D screen on a cell phone, tablet, PC, or TV, or an immersive display device such as AR/VR goggles or a holographic display unit. The observer position information may be used by the renderer to determine whether a virtual camera position is suitable for the 3D Gaussian splat data. In some embodiments, the observer position information further comprises lens characteristics such as focal length and lens geometry correction information, color sampling and/or color space information, and/or image settings and lens information such as lens model and lens manufacturer. The at least one syntax element may include one or more camera settings such as exposure time, aperture, ISO speed ratings, exposure bias, and metering mode. The method can improve rendering accuracy by enabling the renderer to verify that a virtual camera position is suitable for the 3D Gaussian splat data. The method may further comprise decompressing the bitstream prior to rendering. In some embodiments, the decompression is the inverse of a compression mechanism used to generate the bitstream. The volume of space may signify allowed, recommended, suitable, or forbidden observer positions for the rendering of the scene.
(A2) In some embodiments of A1, the at least one syntax element is included in a Supplemental Enhancement Information (SEI) message. The SEI message syntax may be similar to that used in H.264, HEVC, or VVC video coding bitstream formats. In some embodiments, the syntax elements in the SEI message occur in any order unless the order carries semantic weight. The presence of one or more syntax elements may be indicated through a presence flag in the syntax. In some embodiments, the SEI message is referred to as an observer position information (OPI) SEI message. The at least one syntax element may alternatively be included in another format, such as XML, JSON, or binary format.
(A3) In some embodiments of A1 or A2, the at least one syntax element further indicates a maximum distance from the allowed observer positions. The maximum distance may be represented by a syntax element opi_max_distance. In some embodiments, the maximum distance defines at which distance from the allowed observer positions the users can be located. The maximum distance parameter may optionally enable the content creator to control the extent of the viewing experience.
(A4) In some embodiments of any of A1-A3, the at least one syntax element comprises a flag indicating whether six degrees of freedom navigation is allowed. The flag may be represented by a syntax element opi_6dof_flag. In some embodiments, when the 6DoF flag is not set, navigation is constrained to the defined allowed viewing space. By default, without any value defining the allowed viewing space, unconstrained navigation may be allowed and 6DoF navigation may be possible. The 6DoF navigation flag may optionally provide flexibility in defining navigation constraints.
(A5) In some embodiments of any of A1-A4, the observer position information comprises a plurality of source camera positions. The number of camera positions may be indicated by a syntax element opi_num_points. In some embodiments, the syntax element opi_num_points is coded using variable length coding ue(v) to make its representation compact. A fixed length integer such as 8 bits may alternatively be used for the number of camera positions, which may have the advantage of keeping later syntax elements byte-aligned. In some embodiments, the plurality of source camera positions corresponds to cameras in a camera rig that captured the scene. The camera rig may consist of numerous hand-held cell phone cameras that take overlapping pictures or videos of the same scene, or a fixed camera rig with cameras in known positions relative to each other.
(A6) In some embodiments of A5, each source camera position of the plurality of source camera positions is associated with a camera identifier. The camera identifier may be represented by a syntax element opi_camera_id[i]. In some embodiments, the camera identifier is a 16-bit unsigned integer. The camera identifier may be gated by a presence flag opi_camera_id_flag. In some embodiments, the camera identifier enables tracking of individual cameras across multiple frames in a 3DGS sequence with moving cameras.
(A7) In some embodiments of any of A1-A6, the at least one source camera position comprises a position vector represented by Cartesian coordinates. The position vector may alternatively be represented using polar coordinates instead of Cartesian coordinates. In some embodiments, the position vector represents the 3D coordinates where each camera was placed during image capture. The position vector may be obtained from a structure from motion algorithm such as Colmap. In some embodiments, the position vector is indicated by syntax elements opi_point_position_x, opi_point_position_y, and opi_point_position_z.
(A8) In some embodiments of A7, the at least one source camera position further comprises a direction vector indicating an orientation of a source camera. The direction vector may describe the direction in which each camera is pointing. In some embodiments, the orientation is provided as rotation matrices or quaternions. The orientation may be given by a 3×3 rotation matrix that transforms the camera's local coordinates into global coordinates. In some embodiments, the direction vector is indicated by syntax elements opi_point_direction_x, opi_point_direction y, and opi_point_direction_z. The quaternion representation may include a fourth value w indicated by opi_point_direction_w and gated by a flag opi_quaternion_direction_flag. In some embodiments, the quaternion representation stores not only the direction but also the rotation around the direction axis. The quaternion representation may be easier to manipulate in 3D world applications.
(A9) In some embodiments of any of A1-A8, the volume of space indicating allowed observer positions comprises a 3D bounding box defined by a position and a size in each of three dimensions. The 3D bounding box may be defined by two points in 3D space, such as the lower/left/back and the upper/right/forward point of a box. In some embodiments, the 3D bounding box is defined by syntax elements opi_3d_bounding_box_x, opi_3d_bounding_box_y, opi_3d_bounding_box_z, opi_3d_bounding_box_size_x, opi_3d_bounding_box_size_y, and opi_3d_bounding_box_size_z. Any position within the 3D bounding box may be a suitable viewing position. In some embodiments, a file includes more than one 3D bounding box, and volumes within each of the boxes may be a suitable viewing position. A small bounding box may indicate preferred viewing positions, a larger bounding box may indicate viewing positions that offer good quality, and an even larger bounding box may indicate viewing positions where viewing may still be sensible but artifacts begin to become annoying. The 3D bounding box representation may optionally provide a compact way to define allowed viewing positions.
(A10) In some embodiments of any of A1-A9, the volume of space indicating allowed observer positions comprises an intersection between a sphere and a pyramid, the intersection defined by a center position, a radius, and minimum and maximum values for theta and phi angles in spherical coordinates. The intersection may be suitable for a planar or a spherical/semi-spherical camera rig. In some embodiments, the space of allowed views is defined with 8 values: the center coordinates x, y, z, the radius R, and the four angular boundary values theta_min, theta_max, phi_min, and phi_max. The intersection may be defined by syntax elements opi_sphere_center_x, opi_sphere_center_y, opi_sphere_center_z, opi_sphere_radius, opi_sphere_phi_min, opi_sphere_phi_max, opi_sphere_theta_min, and opi_sphere_theta_max. In some embodiments, the view space is the pyramid defined by the center of the sphere and four corner points. The radius may be omitted, in which case the view positions may be defined by a pyramidal cone. The spherical coordinate representation may have limitations when representing viewing regions aligned with certain axes such as the z direction.
(A11) In some embodiments of any of A1-A10, the volume of space indicating allowed observer positions comprises a rectangular region on a sphere defined by a center position, a radius, a quaternion indicating a direction of the rectangular region, and a size of the rectangular region. The rectangular region may be defined in any direction, overcoming limitations of spherical coordinate representations. In some embodiments, the quaternion defines the direction of the rectangular region according to the center of the sphere. The size of the rectangular region may be defined by two values Sx and Sy. The rectangular region may be defined by syntax elements opi_sphere_rectangle_center_x, opi_sphere_rectangle_center_y, opi_sphere_rectangle_center_z, opi_sphere_rectangle_radius, opi_sphere_rectangle_direction_x, opi_sphere_rectangle_direction_y, opi_sphere_rectangle_direction_z, opi_sphere_rectangle_direction_w, opi_sphere_rectangle_size_x, and opi_sphere_rectangle_size_y. The quaternion-based representation may optionally enable representation of viewing regions that would be degenerate in spherical coordinates.
(A12) In some embodiments of any of A1-A11, the volume of space indicating allowed observer positions comprises a convex hull intersection on a sphere defined by a center position, a radius, and a plurality of points on the sphere. {The convex hull may be the part of the sphere that is bounded by the edges connecting the plurality of points. In some embodiments, the allowed view space is defined by n+1 values, with n being the number of points of the convex hull. The convex hull intersection may be defined by syntax elements opi_sphere_point_center_x, opi_sphere_point_center_y, opi_sphere_point_center_z, opi_sphere_point_radius, opi_sphere_num_points, and for each point, opi_sphere_point_theta[i] and opi_sphere_point_phi[i]. In some embodiments, the plurality of points defines an irregular polygonal region on the sphere surface. The convex hull representation may optionally provide flexibility in defining complex viewing regions.
(A13) In some embodiments of any of A1-A12, rendering the 3D Gaussian splat scene representation based on the observer position information comprises determining whether a virtual camera position is within the volume of space indicating allowed observer positions. The determination of whether the virtual camera position is within the volume of space may be performed using geometric checks such as frustum elimination or occlusion heuristics. In some embodiments, pre-computed visibility cones based on known viewer trajectories are used for the determination. The renderer may provide feedback to the user through user interface means indicating whether the virtual camera position is within the allowed volume. In some embodiments, the feedback indicates whether the virtual camera position is preferred, acceptable, or unsuitable. The determination may optionally improve user experience by guiding users toward suitable viewing positions.
(A14) In some embodiments of any of A1-A13, the bitstream comprises a coded video bitstream. The coded video bitstream may be a VVC bitstream carrying Gaussian splat data. In some embodiments, the SEI message is included in the video coding bitstream to convey camera-related metadata. The coded video bitstream may be created from a single camera, in which case there may be only a single camera position in the SEI message. In some embodiments, the coded video bitstream is encoded using a video coding standard such as H.264, HEVC, or VVC.
(A15) In some embodiments of any of A1-A13, the bitstream comprises a point cloud coding bitstream. The point cloud coding bitstream may be a V-PCC bitstream or a G-PCC bitstream. V-PCC (Video-based Point Cloud Compression) uses video technology for point cloud compression. In some embodiments, G-PCC (Geometry-based Point Cloud Compression) is used for sparse point clouds such as LIDAR data. The Gaussian splat representation may be treated as a point cloud with approximately 60 different parameters describing ellipsoids in space. In some embodiments, the point cloud coding bitstream includes an amendment for Gaussian splat coding. In some embodiments, the bitstream supports viewpoint-based streaming, where information pertaining to splats relevant to a viewpoint is selectively conveyed and/or rendered.
(A16) In some embodiments of any of A1-A15, the at least one source camera position is used to derive the volume of space indicating allowed observer positions. In some embodiments, the observer position information comprises the at least one source camera position, and the method further include deriving the volume of space indicating the allowed observer positions based on the at least one source camera position. Deriving the allowed view space from the camera positions may involve complex mathematical calculations. In some embodiments, the renderer performs the calculation of suitable viewing positions based on the source camera positions. The derivation may involve determining a convex hull or bounding region encompassing the source camera positions. Deriving the volume of space at the renderer may optionally provide flexibility for scenarios where multiple Gaussian splat files are combined. In some embodiments, the observer position information comprises both the at least one source camera position and pre-calculated suitable viewing positions, providing a tradeoff between encoder and decoder complexity.
(A17) In some embodiments of any of A1-A16, rendering the 3D Gaussian splat scene representation based on the observer position information comprises determining a rendering quality based on a distance between a virtual camera position and the at least one source camera position. In some embodiments, the rendering quality is highest when the virtual camera position corresponds to one of the source camera positions. The rendering quality may degrade as the virtual camera position moves further from the source camera positions. In some embodiments, moving approximately 10 degrees in angle or twice the distance from a source camera position causes visible artifacts. Pointing the virtual camera in a direction where there is no scene may result in no useful rendering. The quality determination may optionally enable the renderer to provide quality feedback to the user. In some embodiments, optimal viewing positions are co-located with the source camera positions, where the rendering yields a bit-exact and perfect representation.

In some embodiments, one Gaussian splat file or stream is augmented by another one capturing the same scene from a different set of cameras. For example, in a crowdsourcing scenario where a 3D representation of a building is generated from many cell phone cameras, the number of captures may grow from a few to thousands over time. Signaling source camera positions may be advantageous for such integration scenarios because the integration step is straightforward when the camera positions of each capture are available. In contrast, when starting from pre-computed viewpoints, the integration may be difficult because the camera positions may need to be reverse-engineered from the derived viewpoints. In some embodiments, both source camera positions and pre-calculated suitable viewing positions are signaled, providing flexibility for integration scenarios while still offering computational savings at the renderer. Such combined scenarios may inherit the advantages and disadvantages of both solutions, and a system may find a suitable tradeoff based on the specific application requirements.
(A18) In some embodiments of any of A1-A17, the at least one syntax element comprises a persistence flag indicating that the observer position information pertains to a plurality of coded pictures or scenes until cancelled. For example, the persistence flag may be an opi_persistence_flag. In some embodiments, the at least one syntax element comprises a reset flag for cancelling the persistence of the observer position information. For example, the reset flag may be an opi_reset_flag. The persistence mechanism may indicate that the observer position information pertains to all coded pictures or GS scenes until cancelled. In some embodiments, the persistence mechanism is similar to those used in 3D-oriented file formats. The reset flag may perform cancellation of the persisted observer position information. The persistence mechanism may optionally reduce redundancy by avoiding repeated transmission of the same observer position information.
(B1) In one aspect, some embodiments include a method (e.g., the method 950) of generating a bitstream comprising a 3D Gaussian splat scene representation including: (i) acquiring a plurality of images of a scene using one or more cameras; (ii) determining, for each of the one or more cameras, a camera position and a camera orientation; (iii) generating the 3D Gaussian splat scene representation based on the plurality of images and the camera positions and camera orientations; (iv) generating at least one syntax element indicating observer position information, where the observer position information comprises at least one of: (a) at least one source camera position associated with the 3D Gaussian splat scene representation, or (b) a volume of space indicating allowed observer positions for rendering the 3D Gaussian splat scene representation; and (v) encoding the 3D Gaussian splat scene representation and the at least one syntax element into the bitstream. The one or more cameras may comprise a camera rig with fixed positions relative to each other, or hand-held cameras such as cell phones that capture overlapping images of the scene. In some embodiments, the camera positions and orientations are known a priori from a fixed rig configuration. The camera position and camera orientation may be determined using structure from motion techniques such as Colmap when not known a priori. In some embodiments, generating the 3D Gaussian splat scene representation comprises a training step where the parameters of each Gaussian are iteratively refined based on the plurality of images and the camera positions and camera orientations. The volume of space indicating allowed observer positions may be derived from the at least one source camera position. In some embodiments, the at least one syntax element is included in an SEI message in the bitstream. The at least one syntax element may alternatively be encoded in XML, JSON, or binary format within the bitstream. In some embodiments, encoding the bitstream includes compressing the 3D Gaussian splat scene representation using lossless or lossy compression techniques. Generating the volume of space at the encoder may optionally save computational cycles at the decoder. In some embodiments, the method further comprises processing the plurality of images, wherein processing comprises at least one of decoding a compressed image format, color and brightness normalization, adjustment based on optical/lens parameters, or color space conversion. The bitstream may include codepoints that allow a storage/transmission chain or a renderer to reconstruct only parts of the bitstream at reduced quality levels, providing scalability.
(C1) In one aspect, some embodiments include a non-transitory computer-readable storage medium storing one or more instructions and a bitstream that is generated by an encoding method, the one or more instructions when executed by a processor, cause a computing system to perform the encoding method, the encoding method comprising: (i) acquiring a plurality of images of a scene using one or more cameras; (ii) determining, for each of the one or more cameras, a camera position and a camera orientation; (iii) generating the 3D Gaussian splat scene representation based on the plurality of images and the camera positions and camera orientations; (iv) generating at least one syntax element indicating observer position information, where the observer position information comprises at least one of: (a) at least one source camera position associated with the 3D Gaussian splat scene representation, or (b) a volume of space indicating allowed observer positions for rendering the 3D Gaussian splat scene representation; and (v) encoding the 3D Gaussian splat scene representation and the at least one syntax element into the bitstream. The computing system may comprise a CPU, GPU, FPGA, or hardware accelerator for performing the encoding method. In some embodiments, the computing system includes ROM and RAM for storing the instructions. The non-transitory computer-readable storage medium may comprise optical media, a thumb drive, or removable storage. In some embodiments, the bitstream stored on the storage medium is in a file format that enables demand-based streaming. The bitstream may be transmitted from the storage medium via a network interface. The storage medium may optionally enable distribution of the encoded 3D Gaussian splat scene representation to decoders and renderers.

In another aspect, some embodiments include a computing system (e.g., the server system 112) including control circuitry (e.g., the control circuitry 202) and memory (e.g., the memory 214) coupled to the control circuitry, the memory storing one or more sets of instructions configured to be executed by the control circuitry, the one or more sets of instructions including instructions for performing any of the methods described herein (e.g., the methods 900 and 950, A1-A18, and B1).

In yet another aspect, some embodiments include a non-transitory computer-readable storage medium storing one or more sets of instructions for execution by control circuitry of a computing system, the one or more sets of instructions including instructions for performing any of the methods described herein (e.g., the methods 900 and 950, A1-A18, and B1). In some embodiments, a memory or non-transitory computer-readable storage medium stores a bitstream including any of the features (e.g., syntax and encoded information) disclosed herein.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method for processing a three-dimensional (3D) scene representation, the method comprising:
obtaining a bitstream comprising a 3D Gaussian splat scene representation;
parsing, from the bitstream, at least one syntax element indicating observer position information, wherein the observer position information comprises at least one of:
at least one source camera position associated with the 3D Gaussian splat scene representation, or
a volume of space indicating allowed observer positions for rendering the 3D Gaussian splat scene representation; and
rendering the 3D Gaussian splat scene representation based on the observer position information.

2. The method of claim 1, wherein the at least one syntax element is included in a Supplemental Enhancement Information (SEI) message.

3. The method of claim 1, wherein the at least one syntax element further indicates a maximum distance from the allowed observer positions.

4. The method of claim 1, wherein the at least one syntax element comprises a flag indicating whether six degrees of freedom navigation is allowed.

5. The method of claim 1, wherein the observer position information comprises a plurality of source camera positions.

6. The method of claim 5, wherein each source camera position of the plurality of source camera positions is associated with a camera identifier.

7. The method of claim 1, wherein the at least one source camera position comprises a position vector represented by Cartesian coordinates.

8. The method of claim 7, wherein the at least one source camera position further comprises a direction vector indicating an orientation of a source camera.

9. The method of claim 1, wherein the volume of space indicating allowed observer positions comprises a 3D bounding box defined by a position and a size in each of three dimensions.

10. The method of claim 1, wherein the volume of space indicating allowed observer positions comprises an intersection between a sphere and a pyramid, the intersection defined by a center position, a radius, and minimum and maximum values for theta and phi angles in spherical coordinates.

11. The method of claim 1, wherein the volume of space indicating allowed observer positions comprises a rectangular region on a sphere defined by a center position, a radius, a quaternion indicating a direction of the rectangular region, and a size of the rectangular region.

12. The method of claim 1, wherein the volume of space indicating allowed observer positions comprises a convex hull intersection on a sphere defined by a center position, a radius, and a plurality of points on the sphere.

13. The method of claim 1, wherein rendering the 3D Gaussian splat scene representation based on the observer position information comprises determining whether a virtual camera position is within the volume of space indicating allowed observer positions.

14. The method of claim 1, wherein the bitstream comprises a coded video bitstream.

15. The method of claim 1, wherein the bitstream comprises a point cloud coding bitstream.

16. The method of claim 1, wherein the at least one source camera position is used to derive the volume of space indicating allowed observer positions.

17. The method of claim 1, wherein rendering the 3D Gaussian splat scene representation based on the observer position information comprises determining a rendering quality based on a distance between a virtual camera position and the at least one source camera position.

18. The method of claim 1, wherein the at least one syntax element comprises a persistence flag indicating that the observer position information pertains to a plurality of coded pictures or scenes until cancelled.

19. A method for generating a bitstream comprising a three-dimensional (3D) Gaussian splat scene representation, the method comprising:
acquiring a plurality of images of a scene using one or more cameras;
determining, for each of the one or more cameras, a camera position and a camera orientation;
generating the 3D Gaussian splat scene representation based on the plurality of images and the camera positions and camera orientations;
generating at least one syntax element indicating observer position information, wherein the observer position information comprises at least one of:
at least one source camera position associated with the 3D Gaussian splat scene representation, or
a volume of space indicating allowed observer positions for rendering the 3D Gaussian splat scene representation; and
encoding the 3D Gaussian splat scene representation and the at least one syntax element into the bitstream.

20. A non-transitory computer-readable storage medium storing one or more instructions and a bitstream that is generated by an encoding method, the one or more instructions when executed by a processor, cause a computing system to perform the encoding method, the encoding method comprising:
acquiring a plurality of images of a scene using one or more cameras;
determining, for each of the one or more cameras, a camera position and a camera orientation;
generating the 3D Gaussian splat scene representation based on the plurality of images and the camera positions and camera orientations;
generating at least one syntax element indicating observer position information, wherein the observer position information comprises at least one of:
at least one source camera position associated with the 3D Gaussian splat scene representation, or
a volume of space indicating allowed observer positions for rendering the 3D Gaussian splat scene representation; and
encoding the 3D Gaussian splat scene representation and the at least one syntax element into the bitstream.
